(19) United States
(12) Patent Application Publication
(10) Pub. No.: US 2005/0277549 A1
(43) Pub. Date: Dec. 15, 2005

(54) Microcapsules having activated release of core material therein

(75) Inventors: Michael E. Seitz, St. Louis, MO (US); Ronald J. Brinker, St. Louis, MO (US)

Correspondence Address: SENNIGER POWERS LEAVITT AND ROEDEL, ONE METROPOLITAN SQUARE, 16TH FLOOR, ST LOUIS, MO, 63102, US

(73) Assignee: Monsanto Technology LLC, St. Louis, MO (US)

(21) Appl. No.: 11/146,708

(22) Filed: Jun. 7, 2005

Related U.S. Application Data
(60) Provisional application No. 60/579,335, filed on Jun. 14, 2004.

(51) Int. Cl. A01N 25/28; A01N 25/34

(52) U.S. Cl. 504/359; 424/408

(57) ABSTRACT

The present invention is directed to microcapsules having polymeric shells that possess blocking groups (e.g., amine-blocking groups), the removal or cleavage of which act to initiate release of the core material therein, or increase the rate at which such core material is released. The present invention is further directed to the formulation of said microcapsules in aqueous dispersions, to the preparation of said microcapsules, and to the use of such microcapsules and dispersions thereof.

### CROSS-REFERENCE TO RELATED APPLICATION

This application claims priority from U.S. Provisional Patent Application Ser. No. 60/579,335 filed Jun. 14, 2004, the entire contents of which is hereby incorporated by reference.

### BACKGROUND OF THE INVENTION

The present invention is generally directed to the controlled release of encapsulated materials. More particularly, this invention is directed to microcapsules having polymeric shells that possess blocking groups (e.g., amine-blocking groups), the removal or cleavage of which act to initiate release of the core material therein, or increase the rate at which such core material is released. The present invention is further directed to the formulation of said microcapsules in aqueous dispersions, to the preparation of said microcapsules, and to the use of such microcapsules and dispersions thereof.

Microcapsules have been used to encapsulate pesticides and other agricultural actives for many years. However, balancing the release characteristics of the microcapsule for optimum bioefficacy with those needed for long-term package stability remains a challenge for microencapsulation. For example, many of such biological actives have proven to be extremely difficult to contain within microcapsules for the 1 to 2 year storage period generally encountered in the agricultural business.

Additionally, biological actives frequently possess significant water solubility or high volatility. These traits increase the diffusion of the active from the core of the microcapsule into the carrier vehicle thereof, which is usually water, after which the benefits of microencapsulation are lost. The physical form of the active can also aggravate this problem. For example, low melting solids, when encapsulated hot, are known to “super cool” inside the microcapsule, thus failing to crystallize normally therein. Nothing, however, inhibits the crystallization of such actives outside the microcapsules. This change of state can increase the rate of diffusion of the active from inside the microcapsule. Active outside the microcapsule crystallizes from the saturated aqueous carrier, thereby stimulating more diffusion, followed by more crystallization, and so on. In fact, the product which contains the microcapsules can fill with crystals to such an extent that the viscosity thereof increases to an unusable level. The presence of these crystals also creates application problems, for example by clogging spray nozzles. Such actives therefore require a microcapsule with an impermeable shell wall, in order to prevent release of the active in the package.

In contrast to packaging or storage concerns, good bioefficacy requires the active to release easily from the microcapsule at a specific time or over a well-defined period. The life cycle of a particular target, be it a weed or a pest, dictates the release profile of the active, if efficacy is to be maximized. The rate of release from the microcapsule may therefore need to be adjustable, this rate being “tuned” through several iterations of field testing in order to provide the optimum release profile for efficacy. The capsule shell wall that arises out of such testing is often the antithesis of the shell wall designed for package stability.

Microencapsulating such biological actives, therefore, poses a serious dilemma for the formulator. Microcapsules made essentially impermeable in order to achieve long-term package stability invariably reduce or eliminate the bioefficacy of the product. The requirements for shell wall permeability for long-term package stability seldom correspond with the permeability or release requirements needed for optimum performance for the active in the field. The problem is further complicated by release mechanisms that are poorly defined or unreliable in practice. Release is usually the result of porosity induced in the shell wall from excessive stresses that arise from the wall reaction or from mechanical stress experienced during handling or in the field. A burst effect is normally observed in the release profile as a consequence of a poorly encapsulated fraction, followed by a much slower release thereafter. This secondary release phase is strongly effected by the moisture conditions in the field in an antagonistic manner. Mechanical stress from wet and dry cycling accelerates the release, but consistently wet or dry conditions severely retard the release. This often results in a rate of release in this secondary phase below that required for adequate weed control. The dependence on mechanical stresses from the environment makes the release in the field unpredictable and seldom reliable. Mechanical stresses that occur in handling due to pumping, screening and spraying can also cause cracking of the shell wall, and premature release of the active in the package or the field.

### SUMMARY OF THE INVENTION

Briefly, therefore, the present invention is directed to a microcapsule comprising (i) a substantially water-immiscible core material comprising a biologically active compound, and (ii) a shell wall which encapsulates the core material, wherein the shell wall is formed by an interfacial polymerization of an isocyanate monomer with an amine monomer in an encapsulation shell-forming polymerization, and further wherein said shell wall polymer backbone comprises a nitrogen-containing repeat unit therein and at least one blocking group thereon, the breaking of a bond to said blocking group being effective to increase a rate at which the microcapsule releases the biologically active compound.

The present invention is further directed to a method of increasing a rate of release of an encapsulated biologically active compound from a microcapsule comprising a shell wall formed by an interfacial polymerization of an isocyanate monomer with an amine monomer in an encapsulation shell-forming polymerization, said shell wall polymer backbone comprising a nitrogen-containing repeat unit therein having at least one blocking group thereon. The method comprises contacting said microcapsule with a cleaving agent, the cleaving agent being selected to cleave a bond to the blocking group.

The present invention is further directed to a method for the preparation of an aqueous dispersion of microcapsules. The method comprises (i) creating an oil-in-water emulsion comprising an aqueous external phase and a substantially water-immiscible internal phase, the external phase comprising water, an emulsifying agent, and a first amine monomer comprising an amine blocking group, said internal phase comprising an isocyanate monomer and a biologically active compound; and, (ii) reacting the first amine monomer and the isocyanate monomer via interfacial polymerization to encapsulate a substantially water-immiscible core comprising the biologically active compound within a shell comprising a polymer which is a reaction product of the first amine monomer and the isocyanate monomer, wherein the polymer comprises a backbone and a blocking group bonded to an amine in the backbone and wherein the blocking group is subject to removal, removal of the blocking group being effective to increase a rate of release of the biologically active compound from the microcapsules.

The present invention is still further directed to a method for the preparation of an aqueous dispersion of microcapsules. The method comprises (i) creating an oil-in-water emulsion comprising an aqueous external phase and a substantially water-immiscible internal phase, the external phase comprising water, an emulsifying agent, a first amine monomer and a blocking agent effective for blocking the amine functional group of said first amine monomer, the internal phase comprising an isocyanate monomer and a biologically active compound; (ii) reacting said first amine monomer and said blocking agent to form a blocked amine functional group; and, (iii) reacting the first amine monomer and the isocyanate monomer via interfacial polymerization to encapsulate a substantially water-immiscible core comprising the biologically active compound within a shell comprising a polymer which is a reaction product of the amine monomer and the isocyanate monomer, wherein the polymer comprises a backbone and a blocking group bonded to an amine therein, and wherein breaking of a bond to the blocking group is effective to increase a rate of release of the biologically active compound from the microcapsules.

The present invention is still further directed to a method for the preparation of an aqueous dispersion of microcapsules. The method comprises (i) creating an oil-in-water emulsion comprising an aqueous external phase and a substantially water-immiscible internal phase, the external phase comprising water, an emulsifying agent, a first amine monomer, the internal phase comprising an isocyanate monomer and a biologically active compound; (ii) reacting the first amine monomer and the isocyanate monomer via interfacial polymerization to encapsulate a substantially water-immiscible core comprising the biologically active compound within a shell comprising a polymer which is a reaction product of the amine monomer and the isocyanate monomer; and, (iii) reacting said polymer with a blocking agent effective for blocking amine functional groups in said polymer to form a polymer comprising a backbone and a blocking group bound thereto, wherein breaking of a bond to the blocking group is effective to increase a rate of release of the biologically active compound from the microcapsules.

### DETAILED DESCRIPTION OF THE PREFERRED EMBODIMENTS

In accordance with the present invention, it has been discovered that a core material which includes or comprises an active substance, such as a pesticide, may be encapsulated in the form of a microcapsule having a polymeric shell wall which comprises or has incorporated therein a switching or release mechanism that, upon activation (e.g., exposure to some favorable set of environmental conditions after leaving the package in which it has been stored), enables the shell wall to undergo a controlled transition from a state of substantial impermeability (or non-porosity) to one of measured permeability. More specifically, the present invention is in part directed to a microcapsule having a shell wall which comprises a polymer having a nitrogen-containing backbone (e.g., a nitrogen in the main polymer chain or backbone, for example as part of a repeating unit therein). Attached or bound to this nitrogen is an amine-protecting or amine-blocking group which, upon being exposed or subjected to some favorable set of conditions, may be cleaved or removed therefrom, thus causing the rate of release of the core material in the microcapsule to increase.

In this regard it is to be noted that, as used herein, “substantially impermeable” or “substantially non-porous,” as well as variations thereof, may refer, for example, to the shell wall of a microcapsule which, prior to activation or cleaving of the blocking groups, has a half-life of at least about 6 months, about 12 months, about 18 months, or even about 24 months.

It is to be further noted that, as used herein, an amine or amino “blocking” or “protecting” agent generally refers to a reagent which reacts with the nitrogen atom to, in one embodiment, prevent it from participating in a reaction for which it is not intended (e.g., reacting during the polymerization process from which the microcapsule is formed). Additionally, a blocking or protecting group generally refers to that portion or moiety of the agent which is attached or bound to the “blocked” or “protected” nitrogen of the amine group, the breaking of a bond to the group, or the removal of the group, acting to trigger the release of, or increase the rate of release of, the core material contained in the microcapsule.

The microcapsule shell of the present invention may preferably comprise a polyurea polymer; that is, a polymer which include a repeat unit having, for example, the formula: 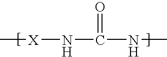
wherein X generally represents some portion, or portions, of the repeat units which, as further defined herein below, may be independently selected from a number of different entities (e.g., different hydrocarbylene linkers). The shell encapsulates a pesticide-containing core material such that, once initiated, molecular diffusion of the pesticide through the shell wall is preferably the predominant release mechanism (as further described elsewhere herein). Thus, the shell is preferably structurally intact; that is, the shell is preferably not mechanically harmed or chemically eroded so as to allow the pesticide to release by a flow mechanism. Further, the shell is preferably substantially free of defects, such as micropores and fissures, of a size which would allow the core material to be released by flow. Micropores and fissures may form if gas is generated during a microcapsule wall-forming reaction. For example, the hydrolysis of an isocyanate generates carbon dioxide. Accordingly, the microcapsules of the present invention are preferably formed in an interfacial polymerization reaction in which conditions are controlled to minimize the in situ hydrolysis of isocyanate reactants. The reaction variables that may preferably be controlled to minimize isocyanate hydrolysis include, but are not limited to: selection of isocyanate reactants, reaction temperature, reaction in the presence of an excess of amine reactants, and shell wall thickness.

In this regard it is to be noted that, as used herein, “flow” of the core material from the microcapsule generally refers to a stream of the material which drains or escapes through a structural opening in the shell wall. In contrast, “molecular diffusion” generally refers to a molecule of, for example, a pesticide, which is absorbed into the shell wall at the interior surface of the wall and desorbed from the shell wall at the exterior surface of the wall.

The polyurea polymer is preferably the product of a reaction between reactants comprising an amine, including a principal amine and optionally an auxiliary amine, with at least one polyisocyanate having two or more isocyanate groups per molecule. The principal amine and the auxiliary amine may be polyfunctional amines (i.e., having two or more amine groups per molecule). Preferably, neither the principal amine nor the auxiliary amine are the products of a hydrolysis reaction involving any of the polyisocyanates with which they react to form the above-referenced polyurea polymer. More preferably, the shell wall is substantially free of a reaction product of an isocyanate with an amine generated by the hydrolysis of said isocyanate. This in situ polymerization of an isocyanate and its derivative amine is less preferred for a variety of reasons described elsewhere herein.

As further described below, the switching or release mechanism may be introduced into the shell wall of the microcapsule of the present invention by, for example, the use of an amine-directed blocking agent on wall precursors employed in the interfacial polymerization microencapsulation process. In one embodiment, the shell wall may comprise a polyfunctional amine-isocyanate polymer such as those disclosed in U.S. Pat. No. 5,925,595 and U.S. patent application Ser. No. 10/728,654 (filed Dec. 5, 2003), the entire contents of which are incorporated by reference herein for all relevant purposes.

Without being held to any particular theory, it is generally believed that, when the microcapsule is exposed to conditions that cleave a bond to the blocking group, the loss of mass (such as when a portion or all of the blocking group is cleaved or removed from the polymer backbone) and/or the increased segmental mobility of the polymer backbone (such as when a portion or all of the blocking group is cleaved or removed from the polymer backbone, or alternatively when bonds connected to the blocking group which act to crosslink one or more polymer chains are cleaved or broken) resulting from or associated with such an event act to increase in the permeability of the shell wall. This increased permeability allows the core material to thus diffuse through the shell wall at some rate which, at least in part, is a function of the polymer of which the shell wall is comprised.

The present invention is believed advantageous, at least in part, because it acts to improve the bioefficacy of the microencapsulated active substance by, for example, delaying its release until some favorable set of environmental conditions exist. The release of a volatile or environmentally unstable pesticide, for example, whose transport mechanism to the plant requires water, can be delayed until moisture is present. In the absence of rain or irrigation following application, the pesticide, when applied unencapsulated or in microcapsules with permeable walls, is prematurely released and lost to volatilization, biodegradation or photodegradation during this non-functional period. The microcapsules of the present invention, having activatable release of the contents therein, is thus desirable for such actives because they hold or contain the volatile or environmentally unstable pesticide therein, thus reducing environmental losses initially, while remaining capable of releasing the active in a controlled manner when the proper moisture conditions existed for efficacy, such as when it rains.

Additionally or alternatively, the present invention may be employed for liquid, non-volatile actives, wherein the blocking group is part of a semi-permeable microcapsule shell wall such that, upon cleavage thereof, the core contents is additionally released at some bioefficacious rate. For example, the semi-permeable shell wall may release the core material following first order kinetics, the release being nearly constant after application up to 50% release and then declining exponentially thereafter. If, at some time after application, the blocking group is cleaved, the release can be accelerated. In this way, the user may avoid the decline in release rate normally experienced as the capsule core is exhausted. By enabling the capsule to breakdown to release the remaining contents therein at a biologically significant rate at the end of the life cycle of the capsule, waste and carry-over may be reduced. The net effect may be higher efficacy for a longer period of time, when compared to shell walls of initially equal but fixed permeabilities.

In this regard it is to be noted that, as used herein, “semi-permeable” generally refers to a microcapsule having a half-life that is intermediate between release from a substantially impermeable microcapsule (as defined elsewhere herein) and a microcapsule that essentially allows the immediate release of core material (i.e., a microcapsule having a half-life of less than about 24 hours, about 18 hours, about 12 hours, or even about 6 hours). For example, a “semi-permeable” microcapsule may a half-life that is between about 5 to about 150 days, about 10 to about 125 days, about 25 to about 100 days, or about 50 to about 75 days.

It is to be noted that, as used herein, the term “pesticide” generally refers to or comprises chemicals used as active ingredients for control of crop and lawn pests and diseases, animal ectoparasites and other pests in public health. The term also refers to or comprises plant growth regulators, pest repellants, synergists, pesticide safeners (which reduce the phytotoxicity of pesticides to crop plants) and preservatives, the delivery of which to the target may expose dermal and especially ocular tissue to the pesticide.

1. Amines

A. Principal Amines

The nitrogen-containing polymers, from which the microcapsule shell wall is prepared or formed, may comprises an amine or polyfunctional amine precursor (e.g., monomer). Among the amines or polyfunctional amines that may be employed to prepare a preferred microcapsule of the present invention are, for example, linear alkylamines or polyalkylamines, which may be represented for example by the structure:
H₂N—X—NH₂
wherein
“X” is selected from the group consisting of —(CH₂)ₐ— and —(C₂H₄)—Y—(C₂H₄)—;
“a” is an integer having a value from about 2 to about 6, or about 3 to about 5; and,
“Y” is selected from the group consisting of —S—S—, —(CH₂)_{b}-Z-(CH₂)_{b}—, and -Z-(CH₂)ₐ-Z-, wherein “b” is an integer having a value between 0 and about 4, or about 1 to about 3, “a” is as defined above, and “Z” is selected from the group consisting of —NH—, —O—, and —S—.
   Examples of such amines or polyfunctional amines that may typically be employed in the present invention include substituted and unsubstituted polyethyleneamines, such as diethylenetriamine and triethylenetetramine, as well as substituted and unsubstituted polypropylenimines. However, it is to be noted that other, similar substituted and unsubstituted polyfunctional amines are also useful, including for example iminobispropylamine, bis(hexamethylene)triamine, cystamine, triethylene glycol diamine (e.g. Jeffamine EDR-148 from Huntsman Corp., Houston, Tex.) and the alkyl diamines, triamine and tetramine having a main alkyl chain of from about 2 to about 6, or about 2 to about 4, carbons in length (e.g., from ethylene diamine up to hexamethylene diamine, triamine or tetramine, with a few number of carbons typically being preferred and/or tetramines typically being preferred over triamines). Among the preferred amines are included, for example, substituted or unsubstituted polyethyleneamine, polypropyleneamine, diethylene triamine and triethylene tetramine.

B. Auxiliary Amines

It is to be noted that the permeability of the shell wall, or the release rate of the core material, may be controlled, upon initiation for example, by varying the relative amounts of 2 or more amines used in the shell wall-forming polymerization reaction (see, e.g., U.S. patent application Ser. No. 10/728,654 (filed Dec. 5, 2003), the entire contents of which is incorporated by reference herein). Accordingly, in addition to those principal amines set forth above, auxiliary amines, such as a polyalkyleneamine or an epoxy-amine adduct, may be useful in providing microcapsules having some predetermined shell wall permeability or release rate, in addition to the permeability imparted thereto upon activation of the microcapsule (e.g., by cleavage of the blocking group from the polymer backbone).

This permeability, or release rate, may change (e.g., increase) as the ratio of the auxiliary amine to a principal amine increases. It is to be noted, however, that alternatively or additionally, as described in greater detail elsewhere herein, permeability may be altered by, for example, (i) adjusting the amount and/or type of isocyanate employed, (ii) using a blend of isocyanates, and/or (iii) using an amine having the appropriate hydrocarbon chain length between the amino groups, all as determined, for example, experimentally using means standard in the art.

In some embodiments, the permeability-altering or auxiliary amine may be a polyalkyleneamine prepared by reacting an alkylene oxide with a diol or triol to produce a hydroxyl-terminated polyalkylene oxide intermediate, followed by amination of the terminal hydroxyl groups. Alternatively, the auxiliary amine may be a polyetheramine (alternatively termed a polyoxyalkyleneamine, such as for example polyoxypropylenetri- or diamine, and polyoxyethylenetri- or diamine) having the following formula: 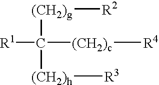
wherein:
c, g and h are each independently a number having a value of 0 or 1;
“R¹” is selected from the group consisting of hydrogen and CH₃(CH₂)_{d}—;
“d” is a number having a value from 0 to about 5, or about 1 to about 4;
“R²” and “R³” are 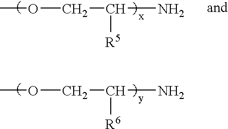
   respectively;
“R⁴” is selected from the group consisting of hydrogen and 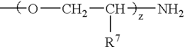
   wherein “R⁵”, “R⁶” and “R⁷” are independently selected from a group consisting of hydrogen, methyl and ethyl; and,
“x”, “y” and “z” are numbers whose total ranges from about to 2 to about 40, or about 5 to about 30, or about 10 to about 20.
   In some embodiments, the value of x+y+z is preferably no more than about 20, or more preferably no more than about 15 or even about 10. Examples of useful auxiliary amine compounds having this formula include amines of the Jeffamine ED series (Huntsman Corp., Houston, Tex.). One of such preferred amines is Jeffamine T-403 (Huntsman Corp., Houston, Tex.), which is a compound according to this formula wherein c, g and h are each 0, R¹ is CH₃CH₂ (i.e., CH₃(CH₂)_{d}, where d is 1), R⁵, R⁶, and R⁷ are each a methyl group and the value of x+y+z is between about 5 and about 6.

The reaction of a polyfunctional amine with an epoxy functional compound has been found to produce epoxy-amine adducts which are also useful as auxiliary amines. Epoxy-amine adducts are generally known in the art. (See, e.g., Lee, Henry and Neville, Kris, Aliphatic Primary Amines and Their Modifications as Epoxy-Resin Curing Agents in Handbook of Epoxy Resins, pp. 7-1 to 7-30, McGraw-Hill Book Company (1967).) Preferably, the adduct has a water solubility as described for amines elsewhere herein. Preferably, the polyfunctional amine which is reacted with an epoxy to form the adduct is an amine as previously set forth above. More preferably, the polyfunctional amine is diethylenetriamine or ethylenediamine. Preferred epoxies include ethylene oxide, propylene oxide, styrene oxide, and cyclohexane oxide. Diglycidyl ether of bisphenol A (CAS # 1675-54-3) is a useful adduct precursor when reacted with an amine in an amine to epoxy group ratio preferably of at least about 3 to 1.

It is to be noted, however, that permeability may also be decreased in some instances by the addition of an auxiliary amine. For example, it is known that the selection of certain ring-containing amines as the permeability-altering or auxiliary amine is useful in providing microcapsules with release rates which decrease as the amount of such an amine increases, relative to the other, principal amine(s) therein. Preferably, the auxiliary amine is a compound selected from the group consisting of cycloaliphatic amines and arylalkyl amines. Aromatic amines, or those having the nitrogen of an amine group bonded to a carbon of the aromatic ring, may not be universally suitable. Exemplary, and in some embodiments preferred, cycloaliphatic amines include 4,4′-diaminodicyclohexyl methane, 1,4-cyclohexanebis(methylamine) and isophorone diamine. Exemplary, and in some embodiments preferred, arylalkyl amines have the structure of the following formula: 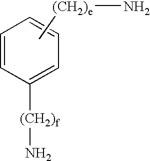
wherein “e” and “f” are integers with values which independently range from about 1 to about 4, or about 2 to about 3. Meta-xylene diamine, from Mitsubishi Gas Co., Tokyo, JP, is a preferred example of an arylalkyl amine.

It is to be noted that “auxiliary amine” and “principal amine” are relative terms as used herein. For example, a principal amine component and a permeability-increasing auxiliary amine component could be arbitrarily renamed as a permeability-decreasing amine and a principal amine, respectively. The effect on permeability that a pair of amines in varying ratios has is more important that the label attached to a given amine structure.

C. Amine Properties

Preferably, the amine, or at least one amine when more than one type of amine is employed, has at least about 3 amino groups or functionalities. Without being held to any particular theory, it is generally believed that in an interfacial polymerization as described herein, the effective functionality of a polyfunctional amine is typically limited to only slightly higher than about 2 and less than about 4. This is believed to be due to steric factors, which normally prevent significantly more than about 3 amino groups in the polyfunctional amine shell wall precursor from participating in the polymerization reaction. A functionality of about 3 or more thus helps to ensure that at least one excess amino group is present for the blocking reaction (i.e., attachment of a blocking group, by reaction of the amine with a blocking agent, as further described elsewhere herein).

However it is to be noted that bifunctional amines may also be used, for example with a bi- or tri-functional blocking agent (as further described herein). Such an agent in these cases is believed to serve as a cleavable coupling agent for the amine, producing a polyfunctional adduct.

It is to be further noted that the molecular weight of the amine monomer or monomers, which may or may not possess an amine blocking group thereon, is preferably less than about 1000 g/mole, and in some embodiments is more preferably less than about 750 g/mole or even 500 g/mole. For example, the molecular weight of the amine monomer or monomers, which may or may not have one or more block amine functionalities therein, may range from about 100 to less than about 750 g/mole, or from about 200 to less than about 600 g/mole, or from about 250 to less than about 500 g/mole. Without being held to a particular theory, it is generally believed that steric hindrance is a limiting factor here, given that bigger molecules may not be able to diffuse through the early-forming proto-shell wall to reach, and react to completion with, the isocyanate monomer in the core during interfacial polymerization.

It is to be still further noted that all of the amine functionalities may not be blocked. Accordingly, the polymer of the shell wall may be prepared, for example, from a mixture of amines, which may be for example substantially the same (differing only by the presence of a blocking group) or different, wherein only a portion of the amine functionalities therein are blocked. In this embodiment, the ratio of blocked to unblocked amines, or amine functionalities, to be used in order to achieve the desired release rate, or change in release rate, upon cleavage or removal of the blocking groups, may be determined experimentally using means standard in the art.

2. Amine Blocking and Blocking Agents

A. Amine Blocking

As previously noted, a switching or release mechanism is present in the shell wall of a microcapsule of the present invention which, upon cleavage thereof, acts to trigger the release of the core material therein, and/or increase the rate at which this core material is released. Such a switching mechanism may be introduced into the shell wall by, for example, the use of an amine-directed blocking group on an amine precursor of the shell wall which is employed in the interfacial polymerization microencapsulation process. More specifically, as illustrated by the scheme presented below (wherein, for example, n is about 1 to about 6, x is about 1 to about 3, R is a hydrocarbylene linkage containing isocyanate, biuret, or urethane group(s), and the wavy bonds extending from R in the shell wall indicate portions of the wall which are not illustrated herein; and, for simplicity, no distinction is made between the reactivity of primary and secondary amines), monomeric shell wall precursors (e.g., polyamine and polyisocyanate monomers or precursors) are selected in ratios that give the desired initial, inherent permeability characteristics and/or handling properties. A “permeability switch” is then added to the polyamine component of the shell wall reaction scheme by reacting it, using means known in the art, with the amine-directed blocking agent, in one embodiment preferably prior to or concurrent with the interfacial polymerization reaction which forms the shell wall. In an alternative embodiment (not illustrated), amine blocking may be performed once polymerization to form the microcapsule has been completed (the microcapsule being reacted with the blocking agent to attach the blocking group thereto). 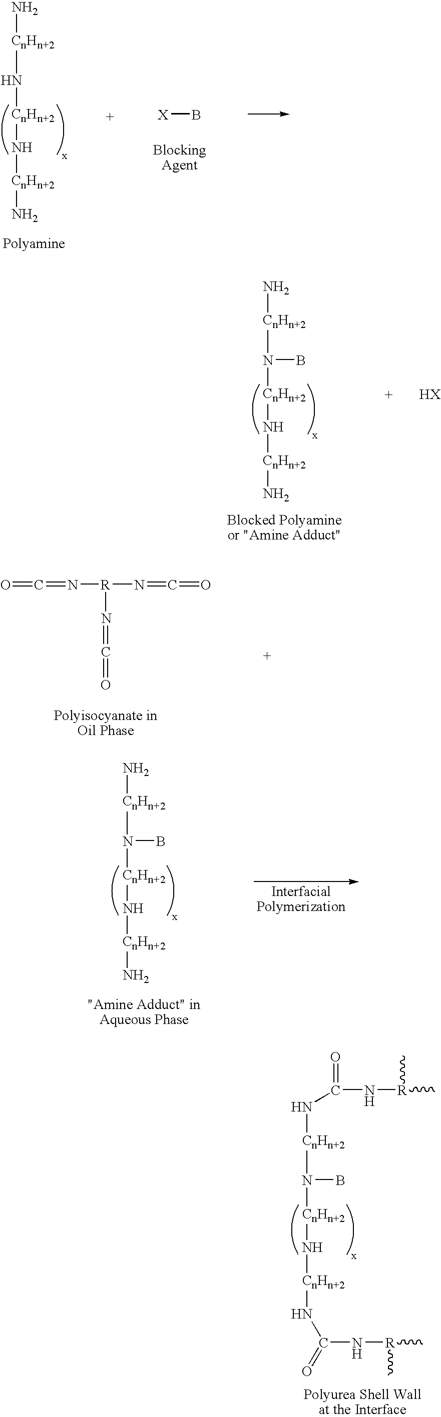
When the blocking reaction is performed prior to the wall-forming polymerization reaction, and as previously noted, typically the amine to be blocked (e.g., the polyamine monomer(s)) will have at least one amine group that is not needed for the interfacial polymerization reaction to occur; that is, the blocking agent is reacted with excess amine groups. Once the blocked amine (or “amine adduct” in the above scheme) is formed, it is then substituted for all, or some portion of, the non-blocked amine that would otherwise be used in the interfacial polymerization step, in order to produce a microcapsule having a shell wall with blocked amino groups therein.

The degree of amine blocking may be expressed in a number of different ways. For example, if the amine monomer typically has about 3 to about 5 amino groups, about 1, 2 or 3 may remain unblocked; that is, about 20% to about 70%, or about 30% to about 60%, of the amino groups may be blocked. Alternatively, or additionally, the degree of blocking within the polymeric shell wall may be expressed in terms of the weight percent (wt %) of the blocking group in the shell wall; for example, the blocking group may comprise about 10 wt % to about 50 wt %, or about 20 wt % to about 40 wt %, of the shell wall. Yet another alternative or additional way of expressing the degree of blocking is in terms of the total moles of amine equivalent, or total number of amino groups to potentially be blocked, to moles of blocking agent; for example, this ratio may range from about 4:0.25 to about 4:1, or about 4:0.5 to about 4:0.75.

In this regard it is to be noted that, as more blocking agent is incorporated into the shell wall (i.e., as more amine groups are blocked), a greater degree of mobility or flexibility will result in the polymer backbone of the shell wall, upon the removal or cleavage of the blocking groups. This increased mobility or flexibility acts to produce a proportionate increase in permeability in the shell wall, and thus release of the core material in the microcapsule. Accordingly, as the amount of blocking agent in the shell wall, or number of blocked amine groups therein, increases, (i) the release of the core material, upon activation of the microcapsule (i.e., cleavage of the blocking groups), increases, (ii) the release half-life of the microcapsule decreases, and (iii) the longevity of weed control decreases, and vice versa. Additionally, it is to be noted that if the amount of blocking agent, or the number of blocked amine groups, is too low, the release of the core material from the microcapsules may be too slow to deliver the minimum amount of active needed per unit time in order to achieve the desired control of the weeds.

The extent of reaction between the blocking agent and the amine has an impact on the degree of blocking which results, and thus ultimately the release profile of the microcapsule. For example, as further illustrated by the Examples herein below, as more time is granted for a blocking agent (e.g., lactose) and an amine (e.g., triethylenetetramine, or TETA) to react, a larger increase in the rate of release (decrease in release half-life, as further described herein) is observed. However, experience to-date suggests that if the reaction period is too long, side reactions may act to render the polyfunctional amine largely non-functional. This suggests that for each blocking reaction, an optimum dwell or reaction time may exist that produces the maximum effect, which will vary with the nature of the blocking agent and reaction and, therefore, may be determined experimentally using means standard in the art. Accordingly, in order to obtain the desired and consistently reproducible results, careful monitoring of the reaction time, such as by means of an in-process monitor, may be advisable for each blocking reaction in order to determine the degree of completion before using the blocked amine in an encapsulation process.

With respect to the blocking of amino groups present in an already-formed microcapsule, it is to be noted that when the shell wall is formed having an excess of amino groups (e.g., 4 amino equivalents for every 3 isocyanate equivalents), an amino group is present in the shell wall which may participate in a post-cure blocking reaction (with, for example, such agents as gluteraldehyde, glyoxal, dextrose, vanillin, or salicylaldehyde). However, the magnitude of the release, or the resulting permeability upon removal of the blocking group, as well as the differences in the sensitivity of pH to changes therein which may cause the blocking group to be eliminated or removed, may be small between the different treatments or blocking agents. In fact, as illustrated in the Examples, experience to-date suggest that, in at least some instances, the absolute values of the release rate and pH for cleaving of the blocking group, closely mirror the results from the untreated (i.e., unblocked) samples. Accordingly, these results suggest that, in such instances, post-polymerization treatment or blocking may not be the preferred method of introducing an activatable site into the shell wall. This is because, in such instances, the release behavior may simply be attributed to the pH dependence observed when free amino groups are present in the shell wall (as further illustrated by the Examples).

B. Blocking Agents

Amine directed protecting agents, also referred to as blocking agents or chemical modifiers, as well as the ways in which they may undergo reaction to be attached to and/or removed from (i.e., “activated”) an amine group, are well known in chemical synthesis. (See, for example, Chemistry of Protein Conjugation and Crosslinking, S. S. Wong, CRC Press (1991), the contents of which is incorporated herein by reference.) Generally speaking, these agents react with an amine functional group of a given amine molecule to form a “conditionally” stable derivative or adduct; conditional in the sense that there exists specific conditions under which this derivative or adduct can be decomposed back into the amine and the blocking agent. As previously noted, the agent may be monofunctional or polyfunctional (i.e., having more than one functional moiety per molecule which reacts with the amine). In those instances wherein the agent has more than one functional moiety (e.g., bifunctional or trifunctional), the agent may act as a crosslinker between two polyamines, and/or between two different positions or points of attachment within the same polyamine.

Essentially any amine-blocking agent may potentially be employed, selected and used in a manner standard in the art. Preferably, however, such agents ordinarily have a molecular weight of less than about 1000 g/mole, or more preferably less than about 750 g/mole, or still more preferably less than about 500 g/mole. For example, the molecular weight of the blocking agent may range from about 100 to less than about 750 g/mole, or from about 200 to less than about 600 g/mole, or from about 250 to less than about 500 g/mole.

Without being held to a particular theory, it is generally believed that, as in the case of the amine monomer, steric hindrance is a limiting factor, given that the diffusion of bigger blocking molecules may (i) limit their ability to react with an amine monomer as the shell wall forming reaction proceeds, (ii) limit the ability of a blocked amine to diffuse and/or react in the wall forming reaction. More specifically, in view of the potential for size-limited diffusion during the interfacial polymerization reaction, it is to be noted that, if the blocking agent is to be attached to, or reacted with, the amine prior thereto, then consideration is to be given to the size of the blocking agent, the size of the amine, and the size of the resulting blocked amine adduct. For example, when a blocked amine is to be part the polymerization reaction, then preferably the blocking agent is of a size such that, upon reaction with the amine to form the blocked amine adduct, the adduct is less than about 1000 g/mole.

Blocking or protecting agents that may be employed in the present invent include, for example, cabonyl- or imine-containing compounds such as: alkyl mono- and dialdehydes (such as formaldehyde, glyoxal, (1,2,3,6-tetrahydrobenzaldehyde)); aromatic mono- and dialdehydes (such as salicylaldehyde, vanillin and terephaldicarboxaldehyde); an alkyl or aromatic ketone; hemiacetals and reducing sugars (such as glucose, fructose, lactose and maltose); oxazolidines (such as 5-hydroxymethyl-1-aza-3,7-dioxabicyclo[3,3,0]octane and 5-ethyl-1-aza-3,7-dioxabicyclo[3,3,0]octane, having the structures 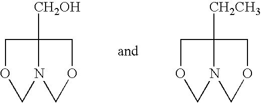
respectively, as well as commercially available agents Amine CS-1246 and Zoldine ZT-55, from Angus Chemical of Northbrook, Ill.), such agents, generally speaking, reacting with an amine in a manner similar to that of an aldehyde (e.g., a reactive formaldehyde condensation); imidoesters (such as methyl or ethyl acetimidate, having the structures 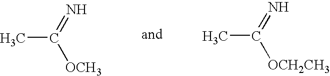
respectively), the hydrochlorides of such reagents undergoing a pH sensitive or dependent reaction with an amine to form a blocked amine as illustrated by the following exemplary reaction scheme: 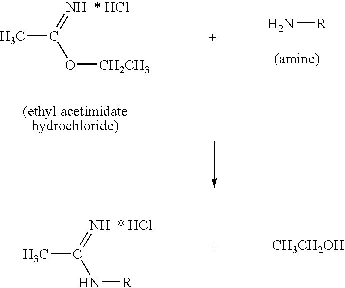
and activated esters (i.e., an ester R′(C═O)OR″ that is made more reactive by means known in the art, such as by either selecting a good leaving group for R″, an example of which is illustrated below, or by modifying R′ to a similar effect). 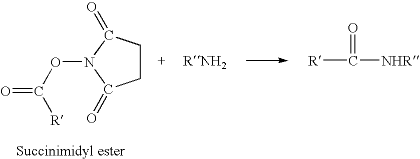
Alternatively, formaldehyde or glyoxal addition adducts with urea or melamine may be used to block amines without polymerization, the adducts being formed under, and stable upon exposure to, basic conditions.

It is to be noted that more than one type or form of blocking agent may be employed for a given microcapsule. For example, in some applications it may be preferably to have multiple release “triggers” (e.g., acid and ultraviolet, for example), such as when a first trigger is needed to initiate essentially any release of the core material and a second trigger is then used to increase the rate of release of the core material as it begins to decrease (e.g., as first order kinetics of the release cease to be followed). Alternatively, or additionally, different blocking groups may be used to help ensure activation of the microcapsule occurs, one blocking agent thus acting as a back-up to the other.

Accordingly, in view of the foregoing it is also to be noted that, in selecting an appropriate blocking agent, consideration may be given not only to the ability of the agent to effectively react with, and thus effectively block, the desire amine group, but also to the conditions under which the resulting blocking group may be cleaved or removed.

3. Isocyanates

When a polyurea shell wall is to be formed, one or more polyisocyanates that may be employed in the shell wall-forming polymerization reaction. For example, polyisocyanates that may be employed in the interfacial polymerization reaction include, for example, those comprising trifunctional adducts of linear aliphatic isocyanates; namely, the products of the reaction of a diisocyanate containing “n” methylene groups and having the formula:
O═C═N—(CH₂)ₙ—N═C═O
where n is an integer having an average value of from about 4 to about 18, from about 6 to about 16, or about 8 to about 14, and a coupling reagent such as water or a low molecular weight triol like trimethylolpropane, trimethylolethane, glycerol or hexanetriol. Exemplary compounds, wherein n is about 6, are the biuret-containing adducts (i.e., trimers) of hexamethylene-1,6-diisocyanate corresponding to the formula: 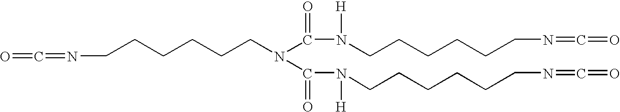
(e.g., Desmodur N3200 (Miles) or Tolonate HDB (Rhone-Poulenc)); a triisocyanate of hexamethylene-1,6-diisocyanate corresponding to the formula: 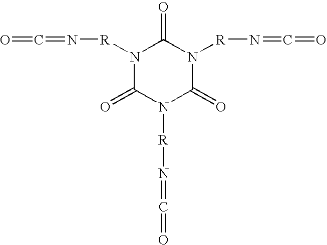
(e.g., Desmodur N3300 (Miles) or Tolonate HDT (Rhone-Poulenc)); and, a triisocyanate adduct of trimethylolpropane and hexamethylene-1,6-diisocyanate corresponding to the formula: 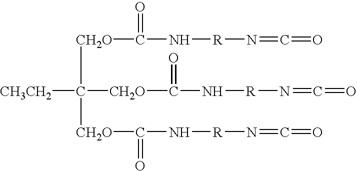
wherein for the above structures R is (CH₂)ₙ, with n being about 6. Aliphatic diisocyanates which contain a cycloaliphatic or aromatic ring segment may be employed in the present invention as well, including for example a meta-tetramethylxylene diisocyanate having the formula: 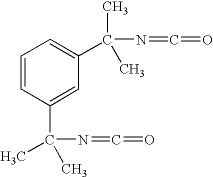
a 4,4′-diisocyanato-dicyclohexyl methane such as Desmodur W (Miles), and isophorone diisocyanate. Finally, isocyanates containing an aromatic moiety are also useful in the present invention, including for example those which contain or comprise methylene-bis-diphenyldiisocyanate (“MDI”) having the formula: 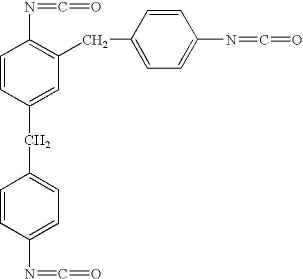
a polymeric MDI (CAS #9016-87-9), toluene diisocyanate, toluene diisocyanate adducts with trimethylolpropane, and MDI-terminated polyols.

It is to be noted that selection of the isocyanate, or isocyanate blend, to be used may be determined experimentally using means known in the art (see, e.g., U.S. Pat. No. 5,925,595, the entire contents of which are incorporated herein for all relevant purposes).

It is to be further noted that isocyanates with an aromatic moiety may have a tendency to undergo in situ hydrolysis at a greater rate than aliphatic isocyanates. Since the rate of hydrolysis is decreased at lower temperatures, isocyanate reactants are preferably stored at temperatures no greater than about 50° C., and isocyanate reactants containing an aromatic moiety are preferably stored at temperatures no greater than about 20° C. to about 25° C., and under a dry atmosphere.

4. Core Material Composition

Generally speaking, useful core materials include those that are a single phase liquid at temperatures of less than about 80° C. Preferably, the core material is a liquid at temperatures of less than about 65° C. More preferably, the core material is a liquid at temperatures of less than about 50° C. The core material may also comprise solids in a liquid phase. Whether liquid or solids in a liquid phase, the core material preferably has a viscosity such that it flows easily to facilitate transport by pumping and to facilitate the creation of an oil in water emulsion as part of the method for preparation of microcapsules discussed herein. Thus, the core material preferably has a viscosity of less than about 1000 centipoise (e.g., less than about 900, 800, 700, 600 or even 500 centipoise). Preferably, the core material is substantially water-immiscible, a property which promotes encapsulation by interfacial polymerization.

In a preferred embodiment, the core material comprises one or more pesticides. As previously noted, the term “pesticide,” as used herein, includes for example chemicals used as active ingredients of products for control of crop and lawn pests and diseases, animal ectoparasites, and other pests in public health. The term also includes plant growth regulators, pest repellants, synergists, herbicide safeners (which reduce the phytotoxicity of herbicides to crop plants) and preservatives, the delivery of which to the target may expose dermal and especially ocular tissue to the pesticide.

The core material may preferably comprise, for example, an acetanilide, such as for example acetochlor, alachlor, butachlor, triallate, or a combination thereof. It is to be noted, however, that the core material may comprise multiple compounds for release (e.g., a pesticide and one or more additives compatible therewith which act to enhance its bioefficacy). For example, a useful combination of compounds is a herbicide and its corresponding safener (e.g., acetochlor and 3-(dichloroacetyl)-5-(2-furanyl)-2,2-dimethyloxazolidine 95%, commercially available from Monsanto Corp.).

It is to be further noted that the core material may optionally comprise a diluent. The diluent may be added to change the solubility parameter characteristics of the core material to increase or decrease the release rate of the active from the microcapsule, once release has been initiated. For example, the core material may comprise between about 0% and about 10% by weight of a diluent, for example between 0.1 and about 8% by weight, between about 0.5% and about 6% by weight, or between about 1% and 5% by weight. However, in some embodiments it may be preferred to minimize the amount of diluent present in the core material by optimizing the polyurea shell to obtain a desired release rate of an active.

It is to be still further noted that a diluent may be selected from essentially any of those known in the art, the compatibility of the diluent with the core material (e.g., the active) and/or the shell wall being determined, for example, experimentally using means standard in the art (see, e.g., U.S. patent application Ser. No.10/728,654 filed Dec. 5, 2003 and U.S. Pat. No. 5,925,595, the entire contents of which are incorporated herein for all relevant purposes). Exemplary diluents include, for example: alkyl-substituted biphenyl compounds (e.g., SureSol 370, commercially available from Koch Co.); normal paraffin oil (e.g., Norpar 15, commercially available from Exxon); mineral oil (e.g., Orchex 629, commercially available from Exxon); isoparaffin oils (e.g., Isopar V, commercially available from Exxon); aliphatic fluids or oils (e.g., Exxsol D110, commercially available from Exxon); alkyl acetates (e.g., Exxate 1000, commercially available from Exxon); aromatic fluids or oils (A 200, commercially available from Exxon); citrate esters (e.g., Citroflex A4, commercially available from Morflex); and, plasticizing fluids or oils used in, for examples, plastics (typically high boiling point esters).

5. Physical Parameters of the Microcapsules

The microcapsules of the present invention may be modeled as spheres to express their size with one number. Specifically, their size may preferably be measured in terms of the diameter of a sphere which occupies the same volume as the microcapsule being measured. The characteristic diameter of a microcapsule may be directly determined, for example, by inspection of a photomicrograph. Preferably a microcapsule of the present invention may have a diameter between about 0.1 and about 60 microns. More preferably a microcapsule may have a diameter between about 0.5 or 1 micron and about 30 microns. Even more preferably a microcapsule may have a diameter between about 1 micron and about 6 or 10 microns.

The size distribution of a sample of microcapsules may preferably be measured using a particle analyzer by a laser light scattering technique. Generally, particle size analyzers are programmed to analyze particles as though they were perfect spheres and to report a volumetric diameter distribution for a sample on a volumetric basis. An example of a suitable particle analyzer is the Coulter LS-130 Particle Analyzer. This device uses laser light at around a 750 mm wavelength to size particles from about 0.4 microns to about 900 microns in diameters by light diffraction.

The thickness of a microcapsule shell wall may be an important factor in some instances. For a reference system having shell precursors which react in a constant ratio to encapsulate a core material having components which are in a constant ratio, an increase in shell thickness leads to a decrease in release rate upon initiation thereof, and conversely a decrease in shell thickness leads to an increase in release rate. However, adjusting release rates by varying the amine blend or isocyanate blend ratio is typically preferred to varying the shell wall thickness because there are practical limits as to how thin or thick shells may be made. Shell walls which are too thin may have insufficient integrity to withstand mechanical forces and remain intact. Shell walls which lack mechanical integrity may be prone to defects and destruction, causing the core material to be released by a flow mechanism rather than the desired diffusion mechanism (both mechanisms having been previously discussed in greater detail elsewhere herein). Shell walls which may be too thick are uneconomical, having more shell wall material than is required to contain the core material. Furthermore, microcapsules having shell walls of greater thickness may take on the disfavored release characteristics of microspheres, in which the core material is dispersed throughout a spherical polymer matrix.

The thickness of a microcapsule shell wall of the present invention may be expressed as a percentage representing the ratio of the weight of the shell to the weight of the core material. Accordingly, the weight ratio of shell to core is preferably less than about 50% (e.g., between about 1% or 5% and about 50%). More preferably the weight ratio is less than about 35% (e.g., between about 5% and 35%. Still more preferably, the weight ratio is less than about 15% (e.g., between about 5% and 15%). Alternatively, the average shell wall thickness may be characterized in conventional linear terms, which are approximately calculated from the aforementioned weight ratio according to the following expression:
Equivalent Thickness=[(W+1)^{1/3}−1]*(0.5×D);
wherein W is the aforementioned ratio of the weight of the shell to the weight of the core material and D is a characteristic diameter of the microcapsule. Generally then, for microcapsules having a wall to core weight ratio between about 5% and about 15%, the equivalent thickness of shells is between about 1.5% and about 5% of the diameter of a microcapsule.

Preferably, the equivalent shell wall thickness of a microcapsule having a diameter between about 0.1 and about 60 microns is between about 0.001 and 4 microns, more preferably between about 0.005 microns and about 2 microns, and still more preferably between about 0.01 microns and about 1.4 microns. Likewise, for microcapsule diameters between about 1 micron and 30 microns, the equivalent shell wall thickness is preferably between about 0.01 and 2 microns thick, more preferably between about 0.05 microns and about 1.5 microns, and still more preferably between about 0.1 microns and about 0.8 microns. For microcapsule diameters between about 1 micron and 6 microns, the equivalent shell wall thickness is preferably between about 0.01 and 0.4 microns thick, more preferably between about 0.05 microns and about 0.3 microns, and still more preferably between about 0.1 microns and about 0.15 microns.

6. Liquid Microcapsule Dispersions: Parameters and Compositions

The microcapsules of the present invention comprise a substantially water-immiscible, agricultural chemical-containing core material encapsulated by an activatable release shell wall, which is preferably substantially non-porous (or substantially impermeable, as previously discussed herein), and permeable to the agricultural chemical contained therein essentially only upon cleaving of the blocking agent, or alternatively is additionally permeable upon cleaving of the blocking agent. As noted herein, the shell wall may preferably comprise a polyurea product of a polymerization of one or more isocyanates and one or more amines (e.g., a principal amine and optionally an auxiliary amine). Additionally, however, a further embodiment of the present invention comprises a liquid dispersion of the microcapsules of the present invention. The liquid medium in which the microcapsules are dispersed is preferably aqueous (e.g., water). The dispersion may optionally, and/or preferably, be further formulated with additives as described elsewhere herein (e.g., a stabilizer, an antifreeze, an anti-packing agent, etc.).

It may be preferred that the size distribution of the microcapsules in the dispersion fall within certain limits. When the distribution is measured with a laser light scattering particle size analyzer, the diameter data is preferably reported as a volume distribution. Thus, the reported median for a population of microcapsules will be volume-weighted, with about one-half of the microcapsules, on a volume basis, having diameters less than the median diameter for the population. For example, the reported median diameter of the microcapsules in an aqueous agricultural dispersion of the present invention may preferably be less than about 15 microns with at least about 90%, on a volume basis, of the microcapsules having a diameter less than about 60 microns. More preferably the median diameter of the microcapsules may be between about 2 microns and about 8 microns with at least about 90%, on a volume basis, of the microcapsules having a diameter of less than about 30 microns. Even more preferably, the median diameter may be between about 2 microns and about 5 microns.

The aqueous dispersion of microcapsules of the present invention may preferably be formulated to further optimize its shelf stability and safe use. Dispersants and thickeners are useful to inhibit the agglomeration and settling of the microcapsules. This function is facilitated by the chemical structure of these additives as well as by equalizing the densities of the aqueous and microcapsule phases. Anti-packing agents are useful when the microcapsules are to be redispersed. A pH buffer can be used to maintain the pH of the dispersion in a range which is safe for skin contact and, depending upon the additives selected, in a narrower pH range than may be required for the stability of the dispersion.

In this regard it is to be noted that, in those instances wherein the amine blocking group or agent is pH sensitive (i.e., they may be removed upon a sufficient change in pH), a pH buffer may also be used to ensure that premature cleavage of the blocking group does not occur. Additionally, it is to be understood that consideration is to be given to the stability of the blocking group when a given additive is to be used in the microcapsule dispersion, again in order to avoid premature cleavage of the blocking group.

Low molecular weight dispersants may solublize microcapsule shell walls, particularly in the early stages of their formation, causing gelling problems. Thus, preferred dispersants may in some embodiments have molecular weights of at least about 1.5 kg/mole, more preferably of at least about 3 kg/mole, and still more preferably may range from about 5 kg/mole to about 50 kg/mole. Dispersants may also be non-ionic or anionic. An example of a high molecular weight, anionic polymeric dispersant is polymeric naphthalene sulfonate sodium salt, such as Irgasol DA (Ciba Specialty Chemicals). Other useful dispersants are gelatin, casein, polyvinyl alcohol, alkylated polyvinyl pyrrolidone polymers, maleic anhydride-methyl vinyl ether copolymers, styrene-maleic anhydride copolymers, maleic acid-butadiene and diisobutylene copolymers, sodium and calcium lignosulfonates, sulfonated naphthalene-formaldehyde condensates, modified starches, and modified cellulosics like hydroxyethyl or hydroxypropyl cellulose, and sodium carboxy methyl cellulose.

Thickeners are useful in retarding the settling process by increasing the viscosity of the aqueous phase. Shear-thinning thickeners may be preferred, because they act to reduce dispersion viscosity during pumping, which facilitates the economical application and even coverage of the dispersion to an agricultural field using the equipment commonly employed for such purpose. The viscosity of the microcapsule dispersion may preferably range between about 100 cps to about 400 cps, as tested with a Haake Rotovisco Viscometer and measured at about 10° C. by a spindle rotating at about 45 rpm. More preferably, the viscosity may range between about 100 cps to about 300 cps. A few examples of useful shear-thinning thickeners include water-soluble, guar- or xanthan-based gums (e.g. Kelzan from CPKelco), cellulose ethers (e.g. ETHOCEL from Dow), modified cellulosics and polymers (e.g. Aqualon thickeners from Hercules), and microcrystalline cellulose anti-packing agents.

Adjusting the density of the aqueous phase to approach the average weight per volume of the microcapsules also slows down the settling process. In addition to their primary purpose, many additives may increase the density of the aqueous phase. Further increase may be achieved by the addition of sodium chloride, glycol, urea, or other salts. The mass to volume ratio of microcapsules of preferred dimensions is approximated by the density of the core material, where the density of the core material is between about 1.1 and about 1.5 g/cm³. Preferably, the density of the aqueous phase is formulated to within about 0.2 g/cm³ of the weight average mass to volume ratio of the microcapsules. More preferably, the density of the aqueous phase ranges from about 0.2 g/cm³ less than the weight average mass to volume ratio of the microcapsules to about equal to the weight average mass to volume ratio of the microcapsules.

Anti-packing agents facilitate redispersion of microcapsules upon agitation of a formulation in which the microcapsules have settled. A microcrystalline cellulose material such as Lattice from FMC is effective as an anti-packing agent. Other suitable anti-packing agents are, for example, clay, silicon dioxide, insoluble starch particles, and insoluble metal oxides (e.g. aluminum oxide or iron oxide). Anti-packing agents which change the pH of the dispersion are preferably avoided, for at least some embodiments.

The dispersions of the present invention are preferably easily redispersed, so as to avoid problems associated with application (e.g., clogging a spray tank). Dispersability may be measured by the Nessler tube test, wherein Nessler tubes are filled with 95 ml of water, then 5 ml of the test formulation is added by syringe. The tube is stoppered, and inverted ten times to mix. It is then placed in a rack, standing vertically, for 18 hours at 20° C. The tubes are removed and smoothly inverted every five seconds until the bottom of the tube is free of material. The number of inversions required to remix the settled material from the formulation is recorded. Preferably, the dispersions of the present invention are redispersed with less than about 100 inversions as measured by a Nessler tube test. More preferably, less than about 20 inversions are required for redispersion.

The pH of the formulated dispersion may preferably range from about 4 to about 9, in order to minimize eye irritation of those persons who may come into contact with the formulation in the course of handling or application to crops. However, if components of a formulated dispersion are sensitive to pH, such as for example the blocking agent, buffers such as disodium phosphate may be used to hold the pH in a range within which the components are most effective. Additionally, a pH buffer such as citric acid monohydrate may be particularly useful in some systems during the preparation of microcapsules, to maximize the effectiveness of a protective colloid such as Sokalan CP9.

Other useful additives include, for example, biocides or preservatives (e.g., Proxel, commercially available from Avecia), antifreeze agents (such as glycerol, sorbitol, or urea), and antifoam agents (such as Antifoam SE23 from Wacker Silicones Corp.).

7. Methods of Preparing Microcapsules and Dispersions Thereof

The present invention is further directed to an encapsulated method which produces mechanically strong microcapsules having an activatable release for the core material contained therein. Release of the core material is controlled by the shell wall of the microcapsule, without the presence of microporosity or the need for mechanical release. As noted elsewhere herein, this is accomplished by manipulating the molecular composition of the shell wall by the introduction of, for example, amine blocking groups in the polymer backbone (e.g., using as a precursor a polyamine containing an amine-directed blocking or protecting group on one or more of the amino groups that is not needed for or used in the interfacial polymerization reaction utilized to prepare the shell wall). Specifically, it has been found that, for example, a bi- or tri-functional isocyanate, or blends of isocyanates, can be polymerized interfacially with 1 or more polyfunctional amines containing thereon at least one blocking group to produce a polyurea shell wall with a permeability that is increased (e.g., initiated) when activated by cleaving the blocking group from the amine at some time after the microcapsule has been prepared.

Generally speaking, an aqueous dispersion of the microcapsules of the present invention may be produced by an interfacial polymerization reaction, either continuously or batchwise, using means generally known in the art. However, preferably an amine or amines are polymerized with a polyisocyanate at the interface of an oil-in-water emulsion. The discontinuous oil phase preferably comprises one or more polyisocyanates and a continuous aqueous phase comprises the amine or amines (e.g., a principal and optionally an auxiliary amine). The oil phase further comprises a core material that preferable comprises a pesticide as the active ingredient. Optionally, when more than 1 amine is used (e.g., a principal amine and an auxiliary amine), these amines may be reacted in a ratio such that the microcapsules have a predetermined permeability with respect to the core material, either prior to activation or additionally upon activation.

In this regard it is to be noted that preferably the amine is not the hydrolysis product of the isocyanate. Rather, it is preferred that the reactants are selected from, for example, the amines and isocyanates disclosed elsewhere herein.

The oil-in-water emulsion is preferably formed by adding the oil phase to the continuous aqueous phase to which an emulsifying agent has been added (e.g., previously dissolved therein). The emulsifying agent is selected to achieve the desired oil droplet size in the emulsion. The size of the oil droplets in the emulsion determines the size of microcapsules formed by the process, as described elsewhere herein. The emulsifying agent is preferably a protective colloid. Polymeric dispersants are preferred as protective colloids. Polymeric dispersants provide steric stabilization to an emulsion by adsorbing to the surface of an oil drop and forming a high viscosity layer which prevents drops from coalescing. Polymeric dispersants may be surfactants and are preferred to surfactants which are not polymeric, because polymeric compounds form a stronger interfacial film around the oil drops. If the protective colloid is ionic, the layer formed around each oil drop will also serve to electrostatically prevent drops from coalescing. Sokalan (BASF), a maleic acid-olefin copolymer, is a preferred protective colloid, as is Irgasol DA (Ciba) and Lomar D (Cognis).

Other protective colloids useful in this invention are gelatin, casein, polyvinyl alcohol, alkylated polyvinyl pyrrolidone polymers, maleic anhydride-methyl vinyl ether copolymers, styrene-maleic anhydride copolymers, maleic acid-butadiene and diisobutylene copolymers, sodium and calcium lignosulfonates, sulfonated naphthalene-formaldehyde condensates, modified starches, and modified cellulosics like hydroxyethyl or hydroxypropyl cellulose, and carboxy methyl cellulose. For the same reasons that high molecular weight dispersants are preferred, high molecular weight protective colloids (i.e., at least about 5, about 10 or even about 15 kg/mole) are also preferred.

The pH may be adjusted during preparation of the microcapsules, such as with citric acid monohydrate, to put the colloid (e.g., Sokalan) in the pH range where the smallest microcapsules may be prepared for a given amount of mechanical energy input through stirring. For example, the pH of the emulsion may preferably be controlled between about 7.0 and about 8.0, or between about 7.5 and about 8.0. Independent of the effect of pH on the effectiveness of the protective colloid, the pH of the mixture during emulsification may preferably be alkaline or neutral (i.e., controlled at a pH greater than about 6). The emulsification step, as well as the associated pH control, is preferably performed prior to the addition of the amine(s).

In view of the foregoing, it is to be noted that, when blocked amines are to be subjected to the microcapsule formation reaction, selection of blocking agents is such that the resulting blocked amine is sufficient stable, such that the blocking group is not removed during microcapsule formation; that is, the blocking group is preferably selected such that it is capable of withstanding, and thus will not be cleaved upon exposure to, the alkaline solution utilized to prepare the microcapsules of the present invention, for the duration of the reaction to form or prepare the microcapsules (e.g., at least about 1 hour, about 2 hours, about 3 hours or more).

To prepare microcapsules of a preferred diameter, the selection of a protective colloid and the conditions of the emulsification step are to be given consideration. For example, the quality of the emulsion, and hence the size of the microcapsules produced, is dependent to some extent upon the stirring operation used to impart mechanical energy to the emulsion. Preferably, the emulsification is accomplished with a high shear disperser. Generally, the microcapsules produced by this process have a size roughly approximated by the size of the oil drops from which they formed. Though particles much smaller than a micron may be advantageous, the economics of such a process may prevent the formation of an emulsion in which the majority of particles have a diameter much smaller than a micron. Therefore, the emulsion is typically mixed to create oil drops having a median diameter preferably less than about 5 microns but typically greater than about 2 microns.

The time that the emulsion remains in a high shear mixing zone is preferably limited to only the time required to create an emulsion having sufficiently small particle size. The longer the emulsion remains in the high shear mixing zone, the greater the degree to which the polyisocyanate will hydrolyze and react in situ. A consequence of in situ reaction is the premature formation of shell walls. Shell walls formed in the high shear zone may be destroyed by the agitation equipment, resulting in wasted raw materials and an unacceptably high concentration of unencapsulated core material in the aqueous phase. Typically, mixing the phases with a Waring blender for about 45 seconds, or with an in-line rotor/stator disperser having a shear zone dwell time of much less than a second, is sufficient. After mixing, the emulsion is preferably agitated sufficiently to maintain a vortex.

The time at which the amine reactants, including for example those amines which do and do not have amine blocking groups attached thereto, are added to the aqueous phase is a process variable which may affect, for example, the size distribution of the resulting microcapsules and the degree to which in situ hydrolysis occurs. Contacting the oil phase with an aqueous phase which contains amines prior to emulsification initiates some polymerization at the oil/water interface. If the mixture has not been emulsified to create droplets having the preferred size distribution, a number of disfavored effects may result, including but not limited to: the polymerization reaction wastefully creates polymer which is not incorporated into shell walls; oversized microcapsules are formed; or, the subsequent emulsification process shears apart microcapsules which have formed. Where the optional auxiliary amine selected is an epoxy-amine adduct which is formed by the reaction of the principal amine and an epoxy reactant, the epoxy reactant may be incorporated into the oil phase prior to emulsification.

In some instances, the negative effects of premature amine addition may be avoided by adding a non-reactive form of the amine to the aqueous phase and converting the amine to its reactive form after emulsion. For example, the salt form of amine reactants may be added prior to emulsification and thereafter converted to a reactive form by raising the pH of the emulsion once it is prepared. This type of process is disclosed in U.S. Pat. No. 4,356,108, which is herein incorporated by reference in its entirety. However, it is to be noted that the increase in pH required to activate amine salts may not exceed the tolerance of the protective colloid to pH swings, else the stability of the emulsion may be compromised. Also, if one or more of the amine groups of the polyfunctional amine has been block prior to use, consideration may also be given to the pH sensitivity thereof, so as to avoid premature removal or cleaving of the blocking agent (or an unacceptable number thereof).

Accordingly, it may be preferable for the amine reactants to be added after the preparation of the emulsion. More preferably, the amine reactants may be added as soon as is practical after the emulsion has been prepared. Otherwise, the disfavored in situ hydrolysis reaction may be facilitated for as long as the emulsion is devoid of amine reactants, because the reaction of isocyanate with water proceeds unchecked by any polymerization reaction with amines. Therefore, amine addition is preferably initiated and completed as soon as practical after the preparation of the emulsion.

There may be, however, situations where it is desirable to purposefully increase the period over which amine reactants are added. For example, the stability of the emulsion may be sensitive to the rate at which the amine reactants are added. Alkaline colloids, like Sokalan, can generally handle the rapid addition of amines. However, rapid addition of amines to an emulsion formed with non-ionic colloids or PVA cause the reaction mixture to gel rather than create a dispersion. Furthermore, if relatively “fast reacting” isocyanates are used (e.g., isocyanates containing an aromatic moiety), gelling may also occur if the amines are added too quickly. Under the above circumstances, it is typically sufficient to extend the addition of the amines over the a period of between about 3 to about 15 minutes, or between about 5 and about 10 minutes. The addition is still preferably initiated as soon as is practical after the emulsion has been prepared.

The viscosity of the external phase is primarily a function of the protective colloid present. The viscosity of the external phase is preferably less than about 50 cps, more preferably less than about 25 cps, and still more preferably less than about 10 cps. The external phase viscosity is measured with a Brookfield viscometer with a spindle size 1 or 2 and at about 20 to about 60 rpm speed. After reaction and without additional formulation, the microcapsule dispersion which is prepared by this process preferably has a viscosity of less than about 400 cps (e.g., less than about 350 cps, about 300 cps, about 250 cps, or even about 200 cps). More preferably the dispersion viscosity is between about 100 and about 200 cps, or about 125 and about 175 cps. The viscosity of microcapsule dispersions is measured according to the methods described elsewhere herein.

The discontinuous oil phase is preferably a liquid or low melting solid. Preferably the oil phase is liquid at temperatures of less than about 80° C. More preferably the oil phase is liquid at temperatures of less than about 65° C. Still more preferably, the oil phase is liquid at temperatures of less than about 50° C. It is preferred that the oil phase is in the liquid state as it is blended into the aqueous phase. Preferably, the pesticide or other active ingredient is melted or dissolved or otherwise prepared as liquid solution prior to the addition of the isocyanate reactant. To these ends, the oil phase may require heating during its preparation.

The discontinuous oil phase may also be a liquid phase which contains solids. Whether liquid, low melting solid, or solids in a liquid, the discontinuous oil phase preferably has a viscosity such that it flows easily to facilitate transport by pumping and to facilitate the creation of the oil-in-water emulsion Thus, the discontinuous oil phase preferably has a viscosity of less than about 1000 centipoise (e.g., less than about 900 centipoise, about 800 centipoise, about 700 centipoise, about 600 centipoise, or even about 500 centipoise).

Additionally, the core material is preferably substantially water-immiscible, a property which promotes encapsulation by interfacial polymerization.

To minimize isocyanate hydrolysis and in situ shell wall formation, a cooling step subsequent to heating the oil phase is preferred when the oil phase comprises an isocyanate comprising an aromatic moiety, because isocyanates comprising an aromatic moiety undergo the temperature-dependent hydrolysis reaction at a faster rate than non-aromatic isocyanates. It has been discovered that the hydrolysis reaction has a negative effect on the preparation of the microcapsules of the present invention. Among other problems, isocyanates hydrolyze to form amines that compete in situ with the selected amines in the polymerization reaction, and the carbon dioxide generated by the hydrolysis reaction may introduce porosity into the prepared microcapsules. Therefore, it is preferred to minimize the hydrolysis of isocyanate reactants at each step of the process of the present invention. Since the hydrolysis reaction rate is directly dependent on the temperature, it is particularly preferred that the internal phase be cooled to less than about 50° C. subsequent to mixing the isocyanate and the core material. It is also preferred that the internal phase be cooled to less than about 25° C. if isocyanates comprising an aromatic moiety are used.

Hydrolysis may also be minimized by avoiding the use of oil phase compositions in which water is highly soluble. Preferably water is less than about 5% by weight soluble in the oil phase at the temperature of the emulsion during the reaction step. More preferably water is less than about 1% soluble in the oil phase. Still more preferably water is less than about 0.1% soluble in the oil phase. It is preferred that the oil phase has a low miscibility in water. Low miscibility in water also promotes the formation of a useful emulsion.

The isocyanate(s), the principal amine(s), and optionally the auxiliary amine(s), may be selected to produce microcapsules which, prior to removal of the blocking group (or, more generally, prior to breaking of a bond to the blocking group) are substantially impermeable or semi-permeable to the core material. Additionally, these reactants, as well as the blocking agents, may be selected to achieve a desired release rate, or increase in release rate, within a targeted range, upon cleavage of the blocking group. Knowing the characteristic release rate of microcapsules created with a principal amine and no auxiliary amine, one skilled in the art may readily select an auxiliary amine to increase or decrease the release rate proportionally to the amount of the auxiliary amine used, in order to achieve the desired release rate.

It is preferred that the amines selected as principal, and optionally auxiliary, amines are sufficiently mobile across an oil-water emulsion interface. Thus, it is preferred that amines selected for the wall-forming reaction have an n-octanol/water partition coefficient wherein the base-10 log of the partition coefficient is between about −4 and about 1. It is also preferred that the reaction occur on the oil side of the oil-water interface, but is it believed that at partition coefficient values lower than about −4 the amines may not be soluble enough in the oil phase to participate sufficiently in the wall-forming reaction. Therefore, the reaction may proceed too slowly to be economical, or the disfavored in situ reaction may predominate. Furthermore, at partition coefficient values above about 1, the amines may not be sufficiently soluble in the water phase to be evenly distributed enough throughout the aqueous phase to facilitate a consistent reaction rate with all the oil particles. Therefore, more preferably the base-10 log of the partition coefficient is between about −3 and about 0.25, or about −2 and about 0.1.

The reaction between the amine and the isocyanate is preferably run with an excess of amines, or more specifically non-blocked amine groups or functionalities, to minimize the disfavored in situ side-reaction involving the hydrolysis of the isocyanate reactant and to maximize conversion of the isocyanate reaction. Preferably the total amount of non-blocked amine groups added to the emulsion is such that the ratio of the amount of added non-blocked amine equivalents to the amount of non-blocked amine equivalents required to complete the reaction is between about 1.05 and about 1.3.

To further reduce the amount of isocyanate hydrolysis and in situ reaction, the reaction is preferably run at as low of a temperature as economics based on the reaction rate will allow. For example, the reaction step may preferably be performed at a temperature between about 40° C. and about 65° C. More preferably, the reaction step may be performed at a temperature between about 40° C. and about 50° C.

The reaction step may preferably be performed to convert at least about 90% of the isocyanate. However, the reaction step may more preferably be performed to convert at least about 95% of the isocyanate. In this regard it is to be noted that the conversion of isocyanate may be tracked by monitoring the reaction mixture around an isocyanate infrared absorption peak at 2270 cm⁻¹, until this peak is essentially no longer detectable. The reaction may achieve 90% conversion of the isocyanate at a reaction time which is within the range of, for example, about one-half hour to about 3 hours, or about 1 to about 2 hours, especially where the core material comprises an acetanilide.

8. Controlling Plant Growth with Microcapsule Dispersions

A. Application

The dispersions disclosed herein are useful as controlled-release pesticides or concentrates thereof. Therefore, the present invention is also directed to a method of applying a dispersion of the microencapsulated pesticides for controlling plant growth. In a preferred embodiment, the dispersion may be applied to an agricultural field in an effective amount for the control of the varieties of plants and pests for which the pesticide has been selected. An “agricultural field” comprises any area where it is desirable to apply pesticides for the control of weeds, pests, and the like, and includes, but is not limited to, farmland, greenhouses, experimental test plots, and lawns.

A microcapsule dispersion may be applied to plants, e.g. crops in a field, according to practices known to those skilled in the art. The microcapsules are preferably applied as a controlled release delivery system for an agricultural chemical or blend of agricultural chemicals contained therein. Because the average release characteristics of a population of microcapsules of the present invention are adjustable, such that the timing of release initiation (or increase release) can be controlled, improved bioefficacy of a given herbicide may be achieved.

When blended for end use on an agricultural field, the dispersion of pesticide-containing microcapsules prior to dilution by the end user may be, for example, less than about 62.5 weight percent microcapsules, or alternatively, less than about 55 weight percent pesticide or other active. If the dispersion is too concentrated with respect to microcapsules, the viscosity of the dispersion may be too high to pump and also may be too high to easily redisperse if settling has occurred during storage. It is for these reasons that the dispersion preferably has a viscosity of less than about 400 centipoise, as describe above.

The dispersion may be as dilute with respect to microcapsule weight percent as is preferred by the user, constrained mainly by the economics of storing and transporting the additional water for dilution and by possible adjustment of the additive package to maintain a stable dispersion. Typically the dispersion is at least about 40 weight percent active (45 weight percent microcapsules) for these reasons. These concentrations are useful compositions for the storage and transport of the dispersions.

However, if storage and transport economics are not critical the dispersions may have lower concentrations of microcapsules. For example, normally such application dispersions have a viscosity of at least about 5 centipoise after dilution by the end user. The viscosity may be measured with a Brookfield viscometer with a spindle size 1 or 2 and at about 20 to about 60 rpm speed. Dispersions which are at least about 5% by weight microcapsules typically exceed this minimum preferred viscosity.

The dispersion may be the only material applied or it may be blended with other agricultural chemicals (e.g., pesticides) or additives for concurrent application. Examples of agricultural chemicals which may be blended include fertilizers, herbicide safeners, complimentary pesticides, and even the free form of the encapsulated pesticide. In one preferred embodiment, the present microcapsules are used in the preparation of a tank mix comprising glyphosate or a salt thereof (e.g., the potassium or monoethanolammonium salt). In such a tank mix, the amine-blocked microcapsules would essentially be activated when combined with the glyphosate-containing formulation (e.g., a Roundup herbicide, commercially available from Monsanto Co.)., because the glyphosate-containing formulation is typically acidic (e.g, pH about 4.5). With such a tank mix, the microcapsules could contain an acetanilide, for example, which is a selective herbicide, in order to advantageously provide residual, long-term weed control, while the glyphosate, a non-selective herbicide, would provide immediate burn-down weed control.

For a stand-alone application of the microcapsules of the present invention, the dispersion is preferably diluted with water prior to application to an agricultural field. Preferably, no additional additives are required to place the dispersion in a useful condition for application as a result of dilution. The optimal concentration of a diluted dispersion is dependent in part on the method and equipment which is used to apply the pesticide. In the case of equipment which performs a spray application, the dispersion is preferably diluted with water to achieve a dispersion viscosity of about 5 centipoise. Typically, a concentrated dispersion of about 45 weight percent microcapsules may be diluted to a preferred viscosity by combining the dispersion and water in a volumetric ratio of about 5 parts dispersion to about 95 parts water.

The effective amount of microcapsules to be applied to an agricultural field is dependent upon the identity of the encapsulated pesticide, the release rate of the microcapsules, the crop to be treated, and environmental conditions, especially soil type and moisture. Generally, application rates of pesticides, such as acetochlor, are on the order of about 2 pounds of pesticide per acre. But, the amount may vary by an order of magnitude or more in some instances. Since the encapsulated pesticide of the present invention may achieve greater effectiveness than unencapsulated pesticide at equivalent application rates, an encapsulated pesticide may be expected to achieve the same effectiveness as unencapsulated pesticide at lower rates. Pesticide use may thereby be reduced.

Use of the encapsulated pesticides of the present invention provides additional advantages over unencapsulated pesticides. A common unencapsulated pesticide package is pesticide emulsified in water. The effectiveness of sprayed pesticide is dependent in part upon the size and distribution of pesticide particles. In a given emulsified pesticide package, particle size distribution is determined in part by the agitation to which the emulsion is subjected prior to application. Emulsion particle size and distribution is hard to control by the average user. Advantageously, the dispersion of the present invention comprises microcapsules having a constant particle size distribution which is set at the time of manufacture. Therefore, no additional care is necessary with regards to controlling particle size and distribution, and the user does not risk wasting pesticide through mishandling the agitation that emulsions require.

B. Activation

When the microcapsules of the present invention are exposed to the proper conditions, one or more bonds to a blocking group may be cleaved, resulting in, for example, (i) the cleaving of a portion or all of a blocking group from the polymer backbone (which in turn results in, for example, the presence of a free amino group on the polymer backbone), and/or (ii) the cleaving of crosslinking bonds between the blocking group and one or more polymer chains bound thereto. Without being held to a particular theory, it is generally believed that the polymeric shell wall does not rupture, because the polymer backbone is not degraded by the cleaving of such bonds (the integrity of the shell wall being maintained, for example, by the presence of other crosslinks that may be present between the isocyanate and other, unblocked amine groups). Rather, the cleaving of such bonds act to impart increased segment mobility within the shell wall, thereby increasing the shell wall permeability. The core material within the microcapsule is then able to permeate or diffuse out through the shell wall.

The conditions under which release of the contents of the microcapsule is initiated, or under which the blocking groups are cleaved, is at least in part a function of the blocking agent employed. Furthermore, the degree of permeability that develops once this cleavage occurs is at least in part a function of the chemical nature of, for example, the isocyanate and amine shell wall precursors, the number of blocking agents in the shell wall, and the rate at which the blocking groups are cleaved.

The chemical literature is replete with examples of such blocking, protecting or coupling agents for amines, as well as the associated stabilities and cleaving conditions, to cover almost any conceivable circumstance. Generally speaking, essentially any technique for blocking and unblocking an amino group may potentially be employed in the present invention, provide (i) the blocking agent employed, and the technique needed for cleaving the blocking group derived or resulting therefrom, are compatible with the other reagents need to prepare the microcapsule (and optionally the dispersion in which the microcapsules are contained), and (ii) the technique enables cleaving of the blocking group after the microcapsules have been removed from the storage container or package, and then prepared for application (e.g., used in a dispersion) and/or actually applied to the field.

Briefly, known options for the blocking and unblocking of an amino group included, for example: (i) a pH trigger (i.e., use of a blocking group that is pH sensitive and may be cleaved from the amino group upon a change in pH); (ii) a photoacid initiator (i.e., use of a blocking group that may be cleaved by exposure to sunlight, wherein the sunlight causes the generation of an acid which then cleaves the blocking group); (iii) a dry acid mix (i.e., use of a blocking group that may be cleaved by exposure to water, the water causing the acid that is co-mixed with the dry microcapsules of the present invention to be dissolved, which then cleaves the blocking group); (iv) an ammonia, or other volatile amine, salt in the storage container or package (i.e., a salt, such as ammonium acetate, is used such that, after application, ammonia or some other volatile amine is lost, causing the pH of the deposited material to become acid, which thus triggers the cleaving of the blocking group); or, (v) where a reversible blocking reaction equilibrium allows, the use of an excess of a particular blocking agent in the storage container or package (i.e., use of a blocking group which is removed due to volatilization or dilution, which results in a shift in the blocking reaction from blocked to unblocked).

In this regard it is to be noted that, when pH is the mechanism by which activation is to occur, the pH at which the blocking groups are cleaved is, at least in part, a function of the nature of the blocking agent employed, and vice versa. For example, in one embodiment the blocking group may be cleaved upon exposure to acid conditions, the pH at which the blocking groups may be cleaved being in the range of about greater than 3 to less than about 7, or from about 3.5 to about 6.5, or from about 4 to about 5.5. In an alternative embodiment, however, the blocking group may be cleaved upon exposure to basic conditions, the pH at which the blocking group may be cleaved being in the range of about 8 to about 10, or about 8.5 to about 9.5 (the amine-blocked microcapsule being formed, for example, at a pH of about 8 over a period of about 1 hour in the presence of an excess of the blocking agent, and then stored at a pH of about 7 to about 7.5).

In this regard it is to be further noted that, in some instances, activation of the present microcapsules (i.e., cleavage of the blocking groups) may occur without the addition of an acid source, the blocking groups being cleaved for example as a result of the acid pH of the soil (as further discussed in the Examples). Without being held to any particular theory, it is generally believed that, upon exposure to the environment, some types of blocking groups are easily degraded or cleaved by, for example, sunlight, moisture, bacteria, etc.

In this regard, and without being held to any particular theory, it is to be still further noted that, as illustrated in the Examples, while a change pH has some effect on the permeability of a polyurea shell wall having nonblocked amino groups therein, utilizing a pH sensitive blocking group thereon enables this effect to be exaggerated, and in some instanced dramatically. Additionally, further decomposition of the blocking group, along with potential acidic by-products formed as a result thereof, may act to produce a self-triggering action which acts to further increase the rate at which other blocking groups are cleaved and core material is released.

It is to be still further noted that, in one embodiment of the present invention, the cleaving agent, utilized to cleaving the blocking group from the amine groups in the shell wall polymer backbone, may be latent; that is, the cleaving agent may require activation by exposure to an external, environmental stimulus, before it becomes effective for cleaving the blocking groups. For example, secondary or latent activators, such as photoacid generators, may also be added to facilitate cleaving of the blocking groups, the photoacid generators, when exposed to actinic radiation, catalyzing deblocking of moieties, like aldehyde-amino adducts, that are sensitive to acids. Triarylsulfonium hexaflourophosphate salts (CA# 744227-35-3 and 68156-13-8), like Cyracure UVI-6990 from Union Carbide (Danbury, Conn.), function in this manner.

In view of the foregoing it may be seen that, by a judicious choice of blocking chemistry, a substantially impermeable microcapsule can be made which will release the core material contained therein when conditions exist most favorable to the mode of action of that material.

9. Half-Life, Release Rate, Diffusion and Shell Wall Permeability

A. Half-Life and Release Rate

Generally speaking, half-life may be employed as an indicator of release rate. The half-life of a microcapsule is the time required for one-half the mass of a compound initially present in the core material to release from a microcapsule. Half-life is therefore inversely related to release rate: a smaller half-life values represent release rates greater than those represented by larger half-life values. The half-life of an aqueous dispersion of microcapsules, for which the total initial mass of encapsulated pesticide is known, can be experimentally determined (as further illustrated in the Examples provided herein). The cumulative mass of pesticide released over time from microcapsules immersed in a relatively large volume of water at a constant temperature may be measured and recorded. This data may then be analyzed in various ways of differing complexity. According to one approach, the cumulative mass value is converted into a percent of initial pesticide released and plotted versus the square root of time, and the half-life can be determined from the equation of a line fit to the data at the point which corresponds to a 50% release. According to an alternative approach, the negative of the logarithm of the fraction of the active remaining in the capsule is plotted versus time. The natural log of 0.5, i.e. In(0.5)=0.693, is divided by the slope of the line to give the half-life. (See, e.g., Omni et al., Controlled Release of Water-soluble Drugs from Hollow Spheres: Experiments and Model Analysis, in Microencapsulation of Drugs, pp. 81-101, Whately, T. ed., Harwood Academic Publishers (1992).) The plot is linear for microcapsules which conform to an idealized model of molecular diffusion through a spherical shell.

Half-lives of microcapsules of this invention may accordingly be calculated using one of these approaches. However, regardless of the method, it is to be noted that the half-life of the microcapsules of present invention may vary widely, depending upon the desired result. For example, in some embodiments the microcapsules may be used soon after preparation, while in others they may be stored for several days, months or even years before use. Accordingly, when in storage (i.e., prior to activation), the microcapsules of the present invention exhibit enhanced stability, having a half-life for example of at least about 6 months, about 12 months, about 18 months, about 24 months or more. In contrast, once these microcapsules have been applied and activated, they may exhibit a half-life of, for example, at least about 5 days, about 10 days, about 20 days, about 40 days, about 60 days or more (e.g., a half-life in the range of about 10 days to about 60 days, or about 20 days to about 40 days).

In contrast to half-life, it is to be noted that the release rate of the core material in the microcapsule in a less controlled environment (e.g., in an agricultural field), is not measured by the above-described method. Rather, the release of a core material such as a pesticide in the field may be indicated by alternative means (e.g., bioefficacy).

The relationship of the duration of bioefficacy of microcapsule dispersions in the field to the release characteristics of microcapsules as measured by one of the half-life methods described above is rarely one-to-one; that is, if bioefficacy is defined as 80% weed control, a dispersion of microcapsules immersed in water may have a calculated half-life of 30 days, yet be bioeffective for 75 days. The exact relationship is not easily predicted, being dependent on complex interactions of multiple variables, but the relationship may be empirically determined by performing standard bioefficacy tests with dispersions of a measured half-life, according methods known in the art.

Accordingly, it is to be noted that the preferred half-life of microcapsules to be applied to crops depends upon numerous factors, including the identity of the crop, the identity of the agricultural chemical, storage duration, and the weather and soil conditions during the growing season. One skilled in the art may take such factors into account and select a herbicidal formulation of the present invention having a useful half-life.

B. Shell Wall Permeability and Diffusion

Preferably, the shell wall of the microcapsules is substantially nonporous, and in one embodiment is also nonpermeable until after cleavage of the amine blocking groups therein has occurred. For example, generally speaking, a non-porous shell wall which is permeable to the encapsulated pesticide can be expected to release the pesticide by molecular diffusion, once activated (i.e., once the blocking groups have been cleaved). Thus, once activated, the plot of cumulative release versus the square root of time may preferably be substantially linear between about 0% and about 50% of pesticide being released; that is, the release of pesticide may behave according to a theoretical model of molecular diffusion through a hollow microcapsule until at least about 50% of the pesticide contained within the microcapsule is released. More preferably, the plot for microcapsules of the invention may be substantially linear to at least about 60%, 70% or 80% of pesticide being released.

When the microcapsules of the present invention have exceeded about 50%, 60%, 70% or 80% release of core pesticides, the release rate may become less than that of the theoretical model. As previously noted, and again without adhering to any particular theory, it is believed that the slower release rate is caused by the collapse of the microcapsules. As core materials are released, it is believed that the microcapsules collapse around the remaining core material until voids form between the core material and the shell wall, such that the core material is no longer in contact with a portion of the internal surface of the shell wall. With a smaller area of core material/shell wall interface, the release rate becomes less than that predicted by the theoretical model. Departure from the theoretical model may also occur in the form of a sudden increase in release rate of core material. For example, as the shell wall collapses, it is possible for the shell wall to rupture, causing such a sudden increase in release rate.

However, in this regard it is to be noted that, in one embodiment of the present invention, the microcapsules may be designed such that one or more types or forms of blocking groups are present, which may be cleaved as the departure from the theoretical model for core material diffusion occurs. In this way, greater permeability may be imparted to the shell wall, thus enabling the core material to diffuse at a greater rate.

It is to be further noted that other indicia of release by molecular diffusion include, for example, temperature dependence according to a molecular diffusion model and differential release rates (i.e. different half-lives) for different compounds present in the core. Temperature dependence of release rate is an effective tool for distinguishing the porous microcapsules produced by reactions involving an unacceptably large degree of in situ hydrolysis of the isocyanate reactants from intact microcapsules which release core materials via molecular diffusion. Porous microcapsules demonstrate a release rate characterized by a half-life of about 1 day or less (as determined, for example, by the procedure of Example 1 D of U.S. patent application Ser. No. 10/728,654 (filed Dec. 5, 2003), which is incorporated herein by reference). However, it is to be noted that not all microcapsules having a calculated half-life of about 1 day or less are porous. Relatively quick-releasing microcapsules, such as those disclosed in the above-referenced U.S. Patent Application, may be distinguished from porous microcapsules by the dependence of release rate on temperature, specifically the water temperature in the noted release rate determination procedure. For example, a porous microcapsule having a release rate characterized by a half-life of about 1 day into water at 30° C. may demonstrate a calculated half-life which is about 2 or 3 days into water at 5° C. The increase in half-life is mostly due to the increase in viscosity of the core material at lower temperatures, causing decreased flow through the pores in the shell wall. For a non-porous shell, release is clearly more temperature dependant. Thus, the increase in measured half-life from release into 30° C. water to release into 5° C. water is much greater, typically about 5 days greater, about 10 days greater, or more.

A second means of distinguishing porous from non-porous microcapsules is the effect of the addition of core diluents on pesticide release rate. Core diluents are discussed in greater detail elsewhere herein. It is also possible to differentiate between porous and non-porous microcapsules by visual observation with the aid of appropriate microscopy techniques. However, the use of techniques based on release rate dependence on temperature and core diluent compositions is preferred.

### EXAMPLES

The following Examples are provided to illustrate one or more aspects of the present invention. They are therefore not to be viewed in a limiting sense.

### Examples 1-3

### Example 1

### [316]

External Phase Preparation:

A 16-ounce jar was charged with 284.7 g of hot water (60° C.). While stirring, 5.8 g of 225A edible gelatin (commercially available from Milligan & Higgins, Johnstown, N.Y.) was added. The gelatin dissolves in 10-20 minutes. The jar was then sealed and placed in a 50° C. oven until needed (experience to-date suggesting that, for best results, the solution is preferably used within 8 hours.)

Internal Phase Preparation:

A 16-ounce jar was charged with 371.9 g of acetochlor that has been preheated to 50° C. Two isocyanates were then weighed into the jar: 10.6 g of Desmodur N3200 [the trifunctional biuret adduct of hexamethylene diisocyanate] and 14.2 g m-TMXDI [meta-tetramethylxylylene diisocyanate]. The solution was agitated to obtain a clear, homogeneous solution. The sealed jar was then placed in a 50° C. oven until needed (experience to-date suggesting that, for best results, the solution is preferably used within 8 hours.)

Amine Adduct/Blocked Amine Preparation:

A 400 ml beaker was charged with 43.8 g (0.3 moles) of TETA and 43.5 g water. Over a 1.5 hour period a solution of 27 g Aerotex M-3 (a 1:3 melamine-formaldehyde resin commercially available from Cytec Industries, West Paterson, N.J.), in 27 g water, was then added dropwise with stirring. After this addition was complete, stirring was continued for 30 minutes. Trietylenetetramine-melamine formaldehyde (TETA-MF) at a 3:1 ratio was obtained.

Emulsification:

The External Phase was added to a commercial Waring blender cup that had been preheated to 50° C. The commercial Waring blender [Waring Products Division, Dynamics Corporation of America, New Hartford, Conn., Blender 700] was powered through a 0-140 Volt variable autotransformer. With the speed of the blender set by the transformer at 60 volts, the Internal Phase was added to the External Phase over a 16 second interval. Within 4 seconds the speed of the blender was increased by increasing the voltage to 110, and this speed was maintained for 15 seconds [time=0]. The emulsion was then transferred to a one liter beaker on a hot plate and stirred.

Cure:

Within 3 minutes after emulsification, 24.6 g of TETA-MF (3:1) from above was added to the stirred emulsion. The beaker was covered and the temperature was maintained at 50° C. for 2 hours (or until the isocyanate infrared absorbance peak at 2270 cm⁻¹ disappeared).

Formulation:

To the above slurry, 20.5 g of a 2% aqueous solution of Proxel (a preservative) and 20 g water were added. Although the capsule slurry may be formulated further in any number of ways, for the purposes of analyzing the release rates of the capsules, the above slurry was simply divided equally into two portions: 360 g which contained no further modifications, labeled 1A (pH=7.86); the other 360 g was modified by the addition of 10 g NaCl and 20 g CaCl₂, labeled 1 B (pH=6.84). In this case, the salts was observed to improve the products package stability by equalizing the densities of the capsules with the External Phase, by reducing the solubility of the acetochlor therein, and by inhibiting residual formaldehyde from thickening the gelatin.

Examples 2 and 3 were prepared by the same procedure. The only significant variant is the amine adduct preparation and the total amounts of the two isocyanates, as further detailed below.

### Examples 2 and 3

### [349 and 344]

Examples 2 and 3 were prepared using substantially the same procedure as outlined above for Example 1, with the only variations being in the amounts of reagents used (including the two isocyanates), and manner in which the amine adduct was prepared. These differences are highlighted in greater detail below, as well as in the summary provided in Table A, below.

### Example 2

### Amine Adduct/Blocked Amine Preparation

A 250 ml beaker was charged with 14.6 g (0.1 mole) TETA and 32.6 g water. With stirring, 18 g ( 0.1 mole) Dextrose was then added over a 45 minute period. The resulting solution was stirred for an additional 60 minutes, and then allowed to stand for 4 days in a sealed bottle.

The resulting product contained 3 equivalents of amine per mole adduct (or blocked amine), and was labeled TETA:Dextrose (1:1). Approximately 30.1 g was used in the remaining portion of the Example.

### Example 3

### Amine Adduct/Blocked Amine Preparation

A 250 ml beaker was charged with 7.4 g (0.054 moles) of salicylic acid and 7.8 g TETA, in 33.3 g water. A clear solution resulted, which was used in the remaining portion of the Example.

### SUMMARY

### Examples 1-3

A summary of the above compositions are provided below in Table A.

TABLE A

| | | Weight (grams) | | |
|---|---|---|---|---|
| Description | Ingredients | Ex. 1 | Ex. 2 | Ex. 3 |
| External Phase | | | | |
| water | water | 284.7 | 284.7 | 284.7 |
| protective colloid | gelatin | 5.8 | 8.2 | 8.2 |
| Internal Phase | | | | |
| core active | acetochlor | 371.9 | 360 | 360 |
| safener (i.e., 3-(dichloroacetyl)-5-(2- | | 0 | 12 | 12 |
| furanyl)-2,2-dimethyloxazolidine, 95%) | | | | |
| flexible triisocyanate | N3200 | 10.6 | 9.4 | 9.8 |
| rigid diisocyanate | TMXDI | 14.2 | 12.1 | 13.1 |
| Crosslinker/Blocked Amine | | | | |
| polyamine adduct | from above | 24.6 | 30.1 | 15.2 |
| water | | 0 | 0 | 33.3 |
| Compounding | | | | |
| preservative | 2% aq. Proxel | 20.5 | 22.4 | 28.7 |
| water | | 20 | 20 | 20 |
| TOTAL | | 752.3 | 758.9 | 785 |
| % Wall on Core | | 10 | 10 | 8 |
| % Of Isocyanate Equivalents | | | | |
| from N3200 | | 33 | 33 | 33 |
| from TMXDI | | 67 | 67 | 67 |
| Release Half-life | | | | |
| at pH 8 | | 3.9 yrs | 1.8 yrs | 3.8 yrs |
| at pH 6.7 | | 3.3 yrs | 1.4 yrs | 2.6 yrs |
| at pH 4 | | 4 days | 6 days | 41 days |

Release Rate Determination Procedure:

For the release rates reported in Table A, as well as all release rates reported elsewhere herein below, the following procedure was employed: 150 mg of microcapsules were weighed into a 100 ml flask (volumetric), and then it was filled to the mark with deionized water and mix. The contents of flask were then transferred to a 0.5 gallon jar, the volumetric flask being rinsed 6 times into the jar with deionized water. The jar was then filled to a net weight of 1000 g with 100 ml of buffer solution and deionized water. The 100 ml of buffer solution was made from pH 7 or pH 4 buffer solution concentrate (commercially available from Fisher Scientific). The medium was sampled at various times, the samples being filtered through a 0.22 micron, 25 mm syringe filter into a vial. The samples were then analyzed by HPLC-UV to determine the concentration of actives in the release medium.

The percent of the core material released into a large volume of water, large enough to be treated as a perfect sink (no back diffusion), was plotted versus the square root of time. The plot was linear and its slope was the (Higuchi) rate constant for release. This constant was used to calculate the time required to release 50% of the capsules core, the release half-life. The release half-life for each of Examples 1-3 are provided in Table A, above. For all other Examples, the results are provided as noted elsewhere herein.

It is to be noted, with respect to the results provided herein, that a release rate test under acid conditions demonstrates what release rate will be obtained if sites degrade. It does not mean, however, that this is the only condition under which the degradation takes place. Release in acidic media is simply a convenient, laboratory condition for degrading sites in the shell wall.

### Example 4

### [276]

External Phase Preparation:

A 16 ounce jar was charged with 262.75 g of hot water (60° C.), and then 27.9 g of Sokalan CP9 (from BASF, Parsippany, N.J.) and 0.725 g of casein were added. The casein dissolved in 20-30 minutes with stirring. The jar was then sealed and placed in a 50° C. oven until needed.

Internal Phase Preparation:

A 16 ounce jar was charged with 372 g of a core solution (of 30 parts Acetochlor plus 1 part 3-(dichloroacetyl)-5-(2-furanyl)-2,2-dimethyloxazolidine, 95%) that had been preheated to 50° C. Two isocyanates were then weighed into the jar; 7.37 g of Desmodur N3200 [the trifunctional biuret adduct of hexamethylene diisocyanate] and 9.98 g m-TMXDI [meta-tetramethylxylylene diisocyanate]. The solution was agitated to obtain a clear, homogeneous solution. The sealed jar was then placed in a 50° C. oven until needed.

Amine Adduct/Blocked Amine Preparation:

To a 4 ounce bottle was added 14.6 g (0.1 mole) of TETA and 50.6 g water, followed by 36.7 g alpha-D lactose monohydrate (0.1 mole, commercially available from Aldrich). The mixture was placed on a “wrist action” shaker overnight. The resulting 1:1 molar ratio of TETA to lactose adduct was used 24 hours after the start of the preparation. The solution was clear with a light yellow-green tint.

Emulsification:

The External Phase was added to a commercial Waring blender cup that had been preheated to 50° C. The single speed, commercial Waring blender [Waring Products Division, Dynamics Corporation of America, New Hartford, Conn., Blender 700] was powered through a 0-140 Volt variable autotransformer. With the transformer at 60 volts, the Internal Phase was added to the External Phase over a 15 second interval. Within 5 seconds the speed of the blender was increased by increasing the voltage to 110, and this speed was maintained for 15 seconds [time=0]. The emulsion was transferred to a one liter beaker on a hot plate and stirred.

Cure:

Within 3 minutes after emulsification, 39.71 g of the 50% solution of TETA [triethylenetetramine]:Lactose (1:1) adduct from above was added to the stirred emulsion. The beaker was covered and the temperature was maintained at 50° C. for 2 hours, at which time the isocyanate infrared absorbance peak at 2270 cm⁻¹ was essentially gone (i.e., 90+% converted).

Formulation:

To the above slurry, 20.5 g of a 2% aqueous solution of Proxel and 0.27 g of Keizan (from Kelco, San Diego, Calif.) was added as preservative and thickener. The microcapsule shell wall was a blend of 67% (by equivalents) TMXDI and 33% Desmodur N3200 cured with the TETA:Lactose (1:1) adduct at an 10% wall to core ratio.

The release rate was measured by the procedure set forth above, at pH 7 and pH 4. The release half-life was determined to be 15 days and 10 days, respectively.

### Example 5

### [285]

External Phase Preparation:

A 16 ounce jar was charged with 262.5 g of hot water (60° C.), and then 23.25 g of Sokalan CP9 (from BASF, Parsippany, N.J.) and 0.604 g of casein were added. The casein dissolved in 20-30 minutes with stirring, after which the pH was adjusted down to 7.2 with 0.446 g of citric acid monohydrate. The jar was then sealed and placed in a 50° C. oven until needed.

Internal Phase Preparation:

A 16 ounce jar is charged with 372 g of a core solution (of 30 parts Acetochlor plus 1 part 3-(dichloroacetyl)-5-(2-furanyl)-2,2-dimethyloxazolidine, 95%) that had been preheated to 50° C. Two isocyanates were the weighed into the jar: 10.55 g of Desmodur N3200 [the trifunctional biuret adduct of hexamethylene diisocyanate] and 14.07 g m-TMXDI [meta-tetramethylxylylene diisocyanate], followed by the addition of 3.72 g of Cyracure UVI-6990 (a photoacid generator from Union Carbide, Danbury, Conn.). The solution was agitated to obtain a clear, homogeneous solution. The sealed jar was then placed in a 50° C. oven until needed.

Amine Adduct/Blocked Amine Preparation:

A 400 ml beaker was charged with 43.8 g (0.3 moles) of TETA and 43.8 g of deionized water, followed by the dropwise addition over a 1.5 hour period of a solution of 27.1 g Aerotex M-3 (a 1:3 melamine-formaldehyde resin from Cytec Industries, West Paterson, N.J.) in 27.3 g water, with stirring. After the addition was complete, stirring was continued for 30 minutes, then the solution was allowed to stand overnight.

Emulsification:

The External Phase was added to a commercial Waring blender cup that had been preheated to 50° C. The single speed, commercial Waring blender [Waring Products Division, Dynamics Corporation of America, New Hartford, Conn., Blender 700] was powered through a 0-140 Volt variable autotransformer. With the transformer at 60 volts, the Internal Phase was added to the External Phase over a 15 second interval. Within 5 seconds the speed of the blender was increased by increasing the voltage to 110, and this speed was maintained for 15 seconds [time=0]. The emulsion was transferred to a one liter beaker on a hot plate and stirred.

Cure:

Within 3 minutes after emulsification, 25.16 g of TETA-MF (3:1) from above was added to the stirred emulsion. The beaker was covered and the temperature was maintained at 50° C. for 1 hour, at which time the isocyanate infrared absorbance peak at 2270 cm⁻¹ disappeared.

Formulation:

To the above slurry, 20.5 g of a 2% aqueous solution of Proxel and 0.27 g of Kelzan (from Kelco, San Diego, Calif.) was added as preservative and thickener. The wall was a blend of 67% (by equivalents) TMXDI and 33% Desmodur N3200 cured with the TETA:MF (3:1) adduct at a 10% wall to core ratio. The release half-life at pH 8 was determined to be 5.6 years.

### Examples 6-13

A series of activatable release microcapsules containing different amounts of the TETA:Lactose adduct were additionally prepared as detailed below. The percent wall to core was varied slightly to increase the initial release rate of the undegraded capsules. This was expected to exaggerate the difference in bioefficacy in the event of activated release (the bioefficacy results are presented in Example 15, below).

### Example 6

### [963]

External Phase Preparation:

A 16 ounce jar was charged with 262.75 g of hot water (60° C.), and then 27.9 g of Sokalan CP9 (from BASF, Parsippany, N.J.) and 0.725 g of casein were added. The casein dissolved in 20-30 minutes with stirring. The jar was then sealed and placed in a 50° C. oven until needed. The pH was 10.34.

Internal Phase Preparation:

A 16 ounce jar was charged with 372 g of a core solution (of 30 parts Acetochlor plus 1 part 3-(dichloroacetyl)-5-(2-furanyl)-2,2-dimethyloxazolidine, 95%) that had been preheated 50° C. Two isocyanates were then weighed into the jar: 10.6 g of Desmodur N3200 [the trifunctional biuret adduct of hexamethylene diisocyanate], and 13.62 g m-TMXDI [meta-tetramethylxylylene diisocyanate]. The solution was then agitated to obtain a clear, homogeneous solution. The sealed jar was then placed in a 50° C. oven until needed.

Amine Adduct/Blocked Amine Preparation:

A 4 ounce bottle was charged with 14.6 g (0.1 mole) of TETA and 23.6 g water, followed by 9 g alpha-D lactose monohydrate (0.025 mole, commercially available from Aldrich). The mixture was placed on a “roller” agitator overnight. The 1:0.25 molar ratio of TETA to lactose adduct was used 9 days after the start of the preparation. The solution was clear with a light yellow-green tint.

Emulsification:

The External Phase was added to a commercial Waring blender cup that had been preheated to 50° C. The single speed, commercial Waring blender [Waring Products Division, Dynamics Corporation of America, New Hartford, Conn., Blender 700] was powered through a 0-140 Volt variable autotransformer. With the transformer at 60 volts, the Internal Phase was added to the External Phase over a 15 second interval. Within 5 seconds, the speed of the blender was increased by increasing the voltage to 110, and this speed was maintained for 15 seconds [time=0]. The emulsion was transferred to a one liter beaker on a hot plate and stirred.

Cure:

Within 3 minutes after emulsification, 21.0 g of the 50% solution of TETA [triethylenetetramine]:Lactose (1:0.25) adduct (from above) was added to the stirred emulsion. The beaker was covered and the temperature was maintained at 50° C. for 2 hours, at which time the isocyanate infrared absorbance peak at 2270 cm⁻¹ was essentially gone (i.e., 90+% converted).

Formulation:

To the above slurry, 20.5 g of a 2% aqueous solution of Proxel and 0.27 g of Kelzan (from Kelco, San Diego, Calif.) was added as preservative and thickener. The wall was a blend of 67% (by equivalents) TMXDI and 33% Desmodur N3200 cured with the TETA:Lactose (1:0.25) adduct at an 9.18% wall to core ratio. The release rate was measured by the above procedure at pH 7, and the release half-life was determined to be 490 days.

### Example 7

### [962]

The same procedure as in Example 6 was followed here, except that the adduct preparation and final percent wall relative to the core were changed, as noted below.

External and Internal Phase:

Prepared the same as in Example 6.

Amine Adduct Preparation:

A 4 ounce bottle was charged with 14.6 g (0.1 mole) of TETA and 33.1 g water, followed by 18 g alpha-D lactose monohydrate (0.05 mole, from Aldrich). The mixture was placed on a “roller” agitator overnight. The 1:0.5 mole TETA to lactose adduct was used 8 days after the start of the preparation. The solution was clear with a light yellow-green tint.

Emulsification:

Same as Example 6.

Cure:

Within 3 minutes after emulsification, 31.28 g of the 49.6% solution of TETA [triethylenetetramine]: Lactose (1:0.5) adduct (from above) was added to the stirred emulsion. The beaker was covered and the temperature was maintained at 50° C. for 2 hours, at which time the isocyanate infrared absorbance peak at 2270 cm⁻¹ was essentially gone (i.e., 90+% converted).

Formulation:

To the above slurry, 20.5 g of a 2% aqueous solution of Proxel and 0.27 g of Kelzan (from Kelco, San Diego, Calif.) was added as preservative and thickener. The wall was a blend of 67% (by equivalents) TMXDI and 33% Desmodur N3200 cured with the TETA:Lactose (1:0.5) adduct at an 10.54% wall to core ratio. The release rate was measured by the above procedure at pH 7, and the release half-life was determined to be 280 days.

### Example 8

### [964]

External Phase Preparation:

A 16 ounce jar was charged with 206.65 g of hot water (60° C.), and then 21.94 g of Sokalan CP9 (from BASF, Parsippany, N.J.) and 0.5702 g of casein were added. The casein dissolved in 20-30 minutes with stirring. The jar was then sealed and placed in a 50° C. oven until needed.

Internal Phase Preparation:

A 16 ounce jar was charged with 292.57 g of a core solution (of 30 parts Acetochlor plus 1 part 3-(dichloroacetyl)-5-(2-furanyl)-2,2-dimethyloxazolidine, 95%) that has been preheated to 50° C. Two isocyanates were then weighed into the jar: 7.91 g of Desmodur N3200 and 10.71 g m-TMXDI. The solution was agitated to obtain a clear, homogeneous solution. The sealed jar was then placed in a 50° C. oven until needed.

Amine Adduct/Blocked Amine Preparation:

A 4 ounce bottle was charged with 14.6 g (0.1 mole) of TETA and 50.6 g water, followed by 36 g alpha-D lactose monohydrate (0.1 mole, from Aldrich). The mixture was placed on a “roller” agitator overnight. The 1:1 mole TETA to lactose adduct was used 9 days after the start of the preparation. The solution was clear with a yellow-green tint.

Emulsification:

Same as Example 6.

Cure:

Within 3 minutes after emulsification, 44.2 g of the 50% solution of TETA [triethylenetetramine]:Lactose (1:1) adduct (from above) was added to the stirred emulsion. The beaker was covered and the temperature was maintained at 50° C. for 2 hours, at which time the isocyanate infrared absorbance peak at 2270 cm⁻¹ is essentially gone (i.e., 90+% converted).

Formulation:

To the above slurry, 16.12 g of a 2% aqueous solution of Proxel and 0.212 g of Kelzan (from Kelco, San Diego, Calif.) was added as preservative and thickener. The wall was a blend of 67% (by equivalents) TMXDI and 33% Desmodur N3200 cured with the TETA:Lactose (1:1) adduct at an 13.92% wall to core ratio. The release rate was measured by the above procedure at pH 7, and the release half-life was determined to be 80 days.

### Example 9

### [988]

External Phase Preparation:

Same as Example 6.

Internal Phase Preparation:

A 16 ounce jar was charged with 372 g of a core solution (of 30 parts Acetochlor plus 1 part 3-(dichloroacetyl)-5-(2-furanyl)-2,2-dimethyloxazolidine, 95%) that has been preheated to 50° C. Two isocyanates were then weighed into the jar: 10.84 g of Desmodur N3200, and 14.67 g m-TMXDI. The solution was agitated to obtain a clear, homogeneous solution. The sealed jar was then placed in a 50° C. oven until needed.

Amine Adduct/Blocked Amine Preparation:

A 4 ounce bottle was charged with 14.6 g (0.1 mole) of TETA and 32.6 g water, followed by 18 g alpha-D lactose monohydrate (0.05 mole, from Aldrich). The mixture was placed on a “roller” agitator overnight. The 1:0.5 mole TETA to lactose adduct was used 15 days later.

Emulsification:

Same as Example 6.

Cure:

Within 3 minutes after emulsification, 33.43 g of the 50% solution of TETA [triethylenetetramine]:Lactose (1:0.5) adduct (from above) was added to the stirred emulsion. The beaker was covered and the temperature was maintained at 50° C. for 2 hours, at which time the isocyanate infrared absorbance peak at 2270 cm⁻¹ was essentially gone (i.e., 90+% converted).

Formulation:

To the above slurry, 20.5 g of a 2% aqueous solution of Proxel and 0.27 g of Kelzan (from Kelco, San Diego, Calif.) was added as preservative and thickener. The wall was a blend of 67% (by equivalents) TMXDI and 33% Desmodur N3200 cured with the TETA:Lactose (1:0.5) adduct at an 11.35% wall to core ratio. The release rate was measured by the above procedure at pH 7, and the release half-life was determined to be 448 days.

### Example 10

### [985]

External Phase Preparation:

A 16 ounce jar was charged with 262.79 g of hot water (60° C.), and then 27.9 g of Sokalan CP9 (from BASF, Parsippany, N.J.) and 0.725 g of casein were added. The casein dissolved in 20-30 minutes with stirring. The jar was then sealed and placed in a 50° C. oven until needed.

Internal Phase Preparation:

A 16 ounce jar was charged with 372 g of a core solution (of 30 parts Acetochlor plus 1 part 3-(dichloroacetyl)-5-(2-furanyl)-2,2-dimethyloxazolidine, 95%) that has been preheated to 50° C. Two isocyanates were then weighed into the jar: 10.83 g of Desmodur N3200 and 14.67 g m-TMXDI. The solution was agitated to obtain a clear, homogeneous solution. The sealed jar was then placed in a 50° C. oven until needed.

Amine Adduct/Blocked Amine Preparation:

A 4 ounce bottle was charged with 14.6 g (0.1 mole) of TETA and 50.6 g water, followed by 36 g alpha-D lactose monohydrate (0.1 mole, from Aldrich). The mixture was placed on a “roller” agitator overnight. The 1:1 mole TETA to lactose adduct was used 8 days after the start of the preparation. The solution was clear with a yellow-green tint.

Emulsification:

Same as Example 6.

Cure:

Within 3 minutes after emulsification, 60.56 g of the 50% solution of TETA [triethylenetetramine]:Lactose (1:1) adduct (from above) was added to the stirred emulsion. The beaker was covered and the temperature was maintained at 50° C. for 2 hours, at which time the isocyanate infrared absorbance peak at 2270 cm⁻¹ was essentially gone (i.e., 90+% converted).

Formulation:

To the above slurry, 20.5 g of a 2% aqueous solution of Proxel and 0.27 g of Kelzan (from Kelco, San Diego, Calif.) was added as preservative and thickener. The wall was a blend of 67% (by equivalents) TMXDI and 33% Desmodur N3200 cured with the TETA:Lactose (1:1) adduct at a 15% wall to core ratio. The release rate was measured by the above procedure at pH 7, and the release half-life was determined to be 313 days.

### Example 11

### Control 1: [401]

External Phase Preparation:

A 0.5 gallon jar was charged with 1215.16 g of hot water (60° C.), followed by 50.67 g of Sokalan CP9 (from BASF, Parsippany, N.J.) and 1.26 g of casein. The casein dissolved in 20-30 minutes with stirring, after which the pH was adjusted down to 7.7 with 0.85 g of citric acid monohydrate. The jar was then sealed and placed in a 50° C. oven until needed.

Internal Phase Preparation:

A 0.5 gallon jar was charged with 1600 g of a core solution (of 30 parts Acetochlor plus 1 part 3-(dichloroacetyl)-5-(2-furanyl)-2,2-dimethyloxazolidine, 95%) that had been preheated to 50° C. Two isocyanates were then weighed into the jar: 90.36 g of Desmodur N3200 [the trifunctional biuret adduct of hexamethylene diisocyanate] and 15.07g m-TMXDI [meta-tetramethylxylylene diisocyanate]. The solution was agitated to obtain a clear, homogeneous solution. The sealed jar was then placed in a 50° C. oven until needed.

Emulsification:

The External Phase was added to a commercial (1 gallon) Waring blender cup that had been preheated to 50° C. The commercial Waring blender [Waring Products Division, Dynamics Corporation of America, New Hartford, Conn., Blender 700] was powered through a 0-140 Volt variable autotransformer. With the speed of the blender set at medium and the transformer at 60 volts, the Internal Phase was added to the External Phase over a 35 second interval. Within 5 seconds the speed of the blender was increased by increasing the voltage to 100, and this speed was maintained for 45 seconds [time=0]. The emulsion was transferred to a four liter beaker on a hot plate and stirred.

Cure:

Within 3 minutes after emulsification, 22.58 g of TETA in 22.58 g of water was added to the stirred emulsion. The beaker was covered and the temperature was maintained at 50° C. for 2 hours, at which time the isocyanate infrared absorbance peak at 2270 cm⁻¹ was essentially gone (i.e., 90+% converted).

Formulation:

To the above slurry, 88.17 g of a 2% aqueous solution of Proxel and 1.17 g of Keizan (from Kelco, San Diego, Calif.) were added as preservative and thickener. The formulation was completed with the addition of 90.9 g of a Sokalan CP9 solution that had been diluted to 1.4% solids with water. The mean particle size was 2.7 microns. The wall was a blend of 20% (by equivalents) TMXDI and 80% Desmodur N3200 cured with TETA at an 8% wall to core ratio. The release rate was measured, and the release half-life was determined to be 34 days.

### Example 12

### Control 2

### [987]

External Phase Preparation:

A 16 ounce jar was charged with 281.3 g of hot water (60° C.), and then 12.94 g of Sokalan CP9 (from BASF, Parsippany, N.J.) and 0.295 g of casein were added. The casein dissolved in 20-30 minutes with stirring. The jar was then sealed and placed in a 50° C. oven until needed. The pH was 10.34.

Internal Phase Preparation:

A 16 ounce jar was charged with 372 g of a core solution (of 30 parts Acetochlor plus 1 part 3-(dichloroacetyl)-5-(2-furanyl)-2,2-dimethyloxazolidine, 95%) that had been preheated to 50° C. Two isocyanates were then weighed into the jar: 12.16 g of Desmodur N3200 [the trifunctional biuret adduct of hexamethylene diisocyanate] and 11.67 g m-TMXDI [meta-tetramethylxylylene diisocyanate]. The solution was agitated to obtain a clear, homogeneous solution. The sealed jar was then placed in a 50° C. oven until needed.

Emulsification:

The External Phase was added to a commercial Waring blender cup that had been preheated to 50° C. The single speed, commercial Waring blender [Waring Products Division, Dynamics Corporation of America, New Hartford, Conn., Blender 700] was powered through a 0-140 Volt variable autotransformer. With the transformer at 60 volts, the Internal Phase was added to the External Phase over a 15 second interval. Within 5 seconds the speed of the blender was increased by increasing the voltage to 110, and this speed was maintained for 15 seconds [time=0]. The emulsion was transferred to a one liter beaker on a hot plate and stirred.

Cure:

Within 3 minutes after emulsification, 6.24 g of TETA [triethylenetetramine] in 6.24 g deionized water were added to the stirred emulsion. The beaker was covered and the temperature was maintained at 50° C. for 2 hours, at which time the isocyanate infrared absorbance peak at 2270 cm⁻¹ was essentially gone (i.e., 90+% converted).

Formulation:

To the above slurry, 20.5 g of a 2% aqueous solution of Proxel and 0.27 g of Kelzan (from Kelco, San Diego, Calif.) was added as preservative and thickener. An additional 8.1 grams of Sokalan CP9 were added to reduce viscosity. The wall was a blend of 59% (by equivalents) TMXDI and 41% Desmodur N3200 cured with the TETA at an 8% wall to core ratio. The release rate was measured by the above procedure at pH 7, and the release half-life was determined to be 3600 days.

### Example 13

### Control 3

Harness EC (commercially available from Monsanto Co., St. Louis, Mo.), an emulsion concentrate of acetochlor, was used for the nonencapsulated control. It contained the same safener at the identical concentration as core solution referenced above (i.e., Harness EC is the core solution plus inerts to aide emulsification and stability).

### Example 14

### Bioefficacy Test

Procedure:

Green foxtail and barnyard grass were seeded (0.5 inch deep) into the standard 4 inch square plots which contained a Dupo silt loam soil mix. The soil mix was previously steam sterilized and prefertilized with Osmocote (14-14-14) slow release fertilizer at a rate of 100 gm per cubic foot. The herbicides from Examples 1, 4 and 5 were applied by a track sprayer in 20 gallons of liquid per acre spray volume. Treatments (4 application rates per formulation, also referred to herein as a rate titration) were made to one soil moisture regime per normal greenhouse operations. All pots were then placed in a warm supplemental lighted (approx. 475 microeinsteins) greenhouse and alternately subirrigated and overhead misted as necessary to maintain adequate moisture for the duration of the test. Approximately 14 days after application, planting efficacy ratings were taken using a HP100 data collector for processing for samples from Example 1 (sample 1B referenced therein), as well as Examples 4 and 5.

Results—Examples 1, 4 and 5:

It was observed, based on the duration of the exposure, that release of the formulas tested from Examples 1-5 were not activated by a 2 hour acid treatment in the stock spray solutions prior to application. Additionally, it was observed that the release tests done on the regular and activated stock solutions failed to show any significant differences in release characteristics. However, the adduct sites did degrade significantly without manual catalysis. The relatively high bioefficacy of the TETA:MF adduct formulas suggests that their release was being activated by external, environmental factors. The sample from Example 1 (i.e., sample 1B, which contained salt densified as detailed therein, using a shell wall made from a blend of 67% TMXDI and 33% Desmodur N3200 (in equivalents) reacted with the activatable amine adduct (TETA-MF) at a 10% all to core ratio) and the sample from Example 5 (which used the same shell wall as sample 1B, but contained a photoacid generator in the core) had release half-lives of 4 years and 5.6 years (4 and 3 years activated), but their average efficacies (i.e., averaged based on the %inhibition for both barnyard grass and foxtail) were observed to be 82% and 87%, respectively (79% and 69% activated, respectively).

It is to be noted that, as used herein, “activated” release values refers to release values determined or measured on the actual greenhouse application mixture (as noted here and elsewhere herein).

All of the test results are set forth in Tables B1 and B2, below.

TABLE B1

| | | | % Inhibition (12 DAT) | | |
|---|---|---|---|---|---|
| | | Acetochlor | barnyard | | |
| Trial No. | Sample | lb/ac (a.i.) | grass | foxtail | Ave. |
| 1 | Control | 0 | 0 | 0 | 0 |
| 2 | Ex. 13 | 0.032 | 95.3 | 99.0 | 97 |
| 3 | Ex. 13 | 0.063 | 98.0 | 99.8 | 99 |
| 4 | Ex. 13 | 0.125 | 99.3 | 100 | 100 |
| 5 | Ex. 13 | 0.250 | 100 | 100 | 100 |
| 6 | Ex. 13 | 0.500 | 100 | 100 | 100 |
| | Average across rates = | | 98.5 | 99.8 | 99.1 |
| 12 | Ex. 1B | 0.032 | 51.5 | 67.5 | 59 |
| 13 | Ex. 1B | 0.063 | 53.8 | 73.8 | 64 |
| 14 | Ex. 1B | 0.125 | 86.3 | 94.5 | 90 |
| 15 | Ex. 1B | 0.250 | 96.3 | 100 | 98 |
| 16 | Ex. 1B | 0.500 | 98.8 | 100 | 99 |
| | Average across rates = | | 77.3 | 87.2 | 82.2 |
| 17 | Ex. 5 | 0.032 | 52.5 | 86.3 | 69 |
| 18 | Ex. 5 | 0.063 | 60 | 91.3 | 76 |
| 19 | Ex. 5 | 0.125 | 86.3 | 96.5 | 91 |
| 20 | Ex. 5 | 0.250 | 96.5 | 100 | 98 |
| 21 | Ex. 5 | 0.500 | 98.5 | 100 | 99 |
| | Average across rates = | | 78.8 | 94.8 | 86.8 |
| 27 | Ex. 4 | 0.032 | 83.8 | 98.8 | 91 |
| 28 | Ex. 4 | 0.063 | 94.3 | 99.3 | 97 |
| 29 | Ex. 4 | 0.125 | 99.3 | 99.8 | 100 |
| 30 | Ex. 4 | 0.250 | 99.8 | 100 | 100 |
| 31 | Ex. 4 | 0.500 | 100 | 100 | 100 |

| | | | |
|---|---|---|---|
| Average across rates = | 95.4 | 99.6 | 97.5 |

TABLE B2

| | | | % Inhibition (12 DAT) | | |
|---|---|---|---|---|---|
| | | Acetochlor | barnyard | | |
| Trial No. | Sample | lb/ac (a.i.) | grass | foxtail | Ave. |
| 1 | Control | 0 | 0 | 0 | 0 |
| 2 | Ex. 13 | 0.032 | 85 | 98.3 | 92 |
| 3 | Ex. 13 | 0.063 | 97.3 | 99.5 | 96 |
| 4 | Ex. 13 | 0.125 | 98.8 | 100 | 99 |
| 5 | Ex. 13 | 0.250 | 100 | 100 | 100 |
| 6 | Ex. 13 | 0.500 | 100 | 100 | 100 |
| | Average across rates = | | 96.2 | 99.6 | 97.9 |
| 12 | Ex. 1B | 0.032 | 53.8 | 52.5 | 53 |
| 13 | Ex. 1B | 0.063 | 58.8 | 76.3 | 68 |
| 14 | Ex. 1B | 0.125 | 76.3 | 97.8 | 87 |
| 15 | Ex. 1B | 0.250 | 81.3 | 98.5 | 90 |
| 16 | Ex. 1B | 0.500 | 98.8 | 99.5 | 99 |
| | Average across rates = | | 73.8 | 84.9 | 79.3 |
| 17 | Ex. 5 | 0.032 | 36.3 | 26.3 | 31 |
| 18 | Ex. 5 | 0.063 | 40 | 62.5 | 51 |
| 19 | Ex. 5 | 0.125 | 66.3 | 83.3 | 75 |
| 20 | Ex. 5 | 0.250 | 78.8 | 98.8 | 89 |
| 21 | Ex. 5 | 0.500 | 95.8 | 99 | 97 |
| | Average across rates = | | 63.4 | 74.0 | 68.7 |
| 27 | Ex. 4 | 0.032 | 75 | 94.5 | 85 |
| 28 | Ex. 4 | 0.063 | 81.3 | 95 | 88 |
| 29 | Ex. 4 | 0.125 | 98 | 100 | 99 |
| 30 | Ex. 4 | 0.250 | 99.5 | 100 | 100 |
| 31 | Ex. 4 | 0.500 | 100 | 100 | 100 |

| | | | |
|---|---|---|---|
| Average across rates = | 90.8 | 97.9 | 94.3 |

On the basis of previous tests with microcapsules of varying release half-lives (that release by simple permeability), one would expect less than 30% weed inhibition (evaluated at 14 day after treatment/application) for a microcapsule with a half-life measured in years. An 80% weed inhibition is typical of formulas with release half-lives measured in days (release half-life of approximately 42). More specifically, the results of samples from Example 1B and Example 5 may be compared, for example, to the following results for samples having shell walls without activatable sites therein (application rate=0.25 lbs a.i./acre of acetochlor):

TABLE B3

| Comparative | Shell Wall | % Inhibition (14 DAT) | Release |
|---|---|---|---|
| Sample | Composition | barnyard grass | Half-life |
| 1 | 33% TMXDI | 82.6 | 42 days |
| 2 | 20% TMXDI | 90.2 | 5 days |
| 3 | 0% TMXDI | 97.6 | 16 hours |

From these results it may be observed that as the concentration of TMXDI in the shell wall decreases, the release rate, and thus the initial bioefficacy, increases. The slower initial release should therefore allow formulations having high concentration of TMXDI in the shell wall to last longer (i.e., provide longer weed control) before their cores are exhausted of the active present therein.

Additionally, it is to be noted that results from shell walls which do not contain activatable sites are provided to serve as references points for expected weed inhibition for a microcapsule with a release half-life measured in years (e.g., Example 1B and 5) and for a microcapsule with a release half-life measured in days (e.g., Example 4). The actual weed inhibition observed in Examples 1B and 5 may be better understood or explained if the release rates from the microcapsules changed after application, from for example years to days, suggesting the microcapsules were activated after application. However, as the results suggest, the exposure conditions present herein were insufficient to actually activate the microcapsules of, for example, Examples 1 B and 5 (which had an “activated” release half-life of 4 years and 3 years, respectively).

### Example 15

### Bioefficacy Test

The series of activatable release microcapsules prepared in Examples 6-13, above, were prepared having a percent wall to core which varied slightly, in an attempt to increase the initial release rate of the undegraded microcapsules. This was expected to exaggerate the difference in bioefficacy in the event of activated release. The bioefficacy results for samples 6-10 are presented, and may be compared to controls 1 and 2 of Examples 11 and 12, respectively. Generally speaking, it is believed that if bioefficacy is proportional to the %lactose and similar to or better than control 1 (Example 11), then an increase in permeability has occurred in the shell wall.

Procedure: Controlled Release Greenhouse Test—Length of Control

A controlled release (CR) test was conducted with Examples 6 through 10, as well as the three controls (i.e., Examples 11-13). Green foxtail was seeded ½ inch deep into standard 4 inch square pots which contained a Dupo silt loam soil mix that had been sterilized previously. All herbicides were applied at 0.25 lb/acre, based on the active ingredient (a.i.) therein, by a track sprayer (as in Example 14, above). Nylon screening was placed ½ inch below the treated soil surface to allow planting at subsequent bioassay dates. The weeds were planted every 7 days and evaluated 2 weeks later. The soil covers were lightly crumbled or broken up and replaced again over the newly seeded pots. The test ran 63 days with eight plantings and evaluations.

Results:

The results are summarized in Table C, below. Specifically, it is to be noted that the five test capsule suspensions contained 12, 22, 22, 39, and 39% lactose at 9, 10.5, 11.4, 13.9 and 15% wall on core, respectively. The amount of wall was increased down the series to equalize the release rates before degradation. In this way, differences in efficacy could be directly correlated with the number of activatable sites in the wall (lactose content). Two controls, 1 (Example 11) and 2 (Example 12), with fixed release rates that bracketed the above test samples—fast (t_{1/2}=34 day) and slow (t_{1/2} of about 9.8 years)—were included to provide perspective.

It is to be noted that the analysis of the results was complicated by an unplanned change in irrigation midway through the test. The overhead misting malfunctioned between the 28 and 35 day assays, after which only bottom irrigation was operating. This caused a discontinuity in the data at 35 days. The data points at 0 through 28 days were analyzed separately from the data obtained in days 35 through 63. The later interval is the more significant in terms of length of control.

Analyzing the results broadly by class—EC, fixed release, and activatable release—reveals a trend towards higher levels of control for a longer interval with the activatable release capsules. The EC dropped continuously from 65% at day 35 to zero efficacy by day 56, and the two controls with fixed releases dropped from 70% to 5% (fast) and 20% (slow) by day 63. The efficacy of all of the activatable capsules, on the other hand, declined at a much slower rate. The efficacy of the group dropped from the 72-95% range of control at day 35 to the 40-62% levels of control by day 63. These results are consistent with the predicted behavior based on site degradation within the shell wall. The breakdown and loss of lactose from the wall should increase its permeability and thereby its release rate. This increase would in some part offset the decline in release rate observed in first order release as the core concentration drops below 50%. The net effect should be higher efficacy for a longer period when compared to shell walls of initially equal but fixed permeabilities, and this was observed.

Within the activatable group, the trend in efficacy roughly followed the % lactose content. A formula with the most lactose (Example 8=39%) produced higher efficacy (97%) at 35 days than the others, but one of the lower efficacies at 63 days (45%). By comparison, the lowest lactose content (Example 6=12%), provided only 81% weed control at 35 days, but gave the best control at 63 days (60%). The weed inhibition of an intermediate formula (Example 7=22%) fell somewhere generally between these two extremes (93% at 35 days, 55% at 63 days). These differences in weed control are also consistent with the model. The more sites in the shell wall, the greater the permeability increase, boosting its efficacy while shortening its length of control. Conversely, as the numbers of sites are lowered, the magnitude of the shift in permeability shrinks, resulting in longer control with a lower level of up-front control. In the ideal case, the degradation rate would exactly offset the first order rate decline, resulting in constant release (i.e., pseudo zero order release, which is a goal).

TABLE C
[at 0.25 lb (a.i.)/acre acetochlor on green foxtail]

| | | Moles | | | | % Weed | % Weed | Release |
|---|---|---|---|---|---|---|---|---|
| | | TETA to | % Wall on | % Lactose | % Lactose | Control at 35 | Control at 63 | Half-life |
| Ex. # | Batch No. | Lactose | Core | in Wall | on Core | Days | Days | (Days) |
| 6 | 963 | 1:0.25 | 9.2 | 12 | 1.1 | 81 | 60 | 490 |
| 7 | 962 | 1:0.5 | 10.5 | 22 | 2.3 | 93 | 55 | 280 |
| 9 | 988 | 1:0.5 | 11.35 | 22 | 2.5 | 87 | 42 | 448 |
| 4 | 276 | 1:1 | 10 | 38 | 3.8 | Not Tested | Not Tested | 15 |
| 8 | 964 | 1:1 | 13.9 | 39 | 5.4 | 97 | 45 | 80 |
| 10 | 985 | 1:1 | 15 | 39 | 5.8 | 72 | 38 | 313 |
| 11 | 401 | 1:0 | 8 | 0 | 0 | 70 | 5 | 34 |
| (Ctrl 1) | | | | | | | | |
| 12 | 987 | 1:0 | 8 | 0 | 0 | 68 | 20 | 3600 |
| (Ctrl 2) | | | | | | | | |
| 13 | Harness EC | Commercial | No | Emulsion | Concentrate | 63 | 0 | 0 |
| (Ctrl 3) | | | Capsules | | | | | |

In this regard it is to be noted that the efficacy of Control 2 may appear to be rather high (given that the half-life for this sample is several years and that one would expect, as noted in Example 14, less than 30% weed inhibition for such a sample at 14 DAT). However, if a bioevaluation as in Example 14, above, is conducted as a rate titration on barnyard grass, the efficacy of Control 2 is as presented below in Table D:

TABLE D

| | | % Inhibition |
|---|---|---|
| | Acetochlor | (average, 14 DAT) |
| Trial No. | lb/ac (a.i.) | barnyard grass |
| 1 | 0.032 | 3 |
| 2 | 0.063 | 8 |
| 3 | 0.125 | 10 |
| 4 | 0.250 | 26 |
| 5 | 0.500 | 71 |

In this regard it is to be further noted that, generally speaking, for a given weed species formulations with a longer release half-life are believed to give better control at later evaluations than early evaluations (i.e., better control after more days after treatment, or DAT, have elapsed, as compared to fewer days after treatment). A very slow release (i.e., very little, for example, acetochlor available early on) allows break through of weeds. Once these weeds emerge and reach a certain height, the acetochlor becomes ineffective. This is typically the main failure mode for formulations that release too slowly (i.e., poor up-front, or early season, control). In a longevity test, the plants being used for the test have sat bare, and under the same conditions of heat and watering, without weeds for 35 and 63 days (as compared, for example, to results measured after only 14 DAT). This longer interval allows some acetochlor to accumulate in the soil, which is the net effect of the continued release of acetochlor (gain) even at this late date (albeit slow) and the loss (run-off) due to (simulated) rainfall. The faster releasing formulations are exhausted at these later dates, nothing being released, so the loss dominates, and control is lost.

### Example 16

### [340]

### Internal Control of the Effect of Introducing

### Free, Unblocked Amino Groups into a Shell Wall

Shell walls with excess amino groups exhibit to some extent pH dependence in their release. The trigger is a change in pH that may be externally initiated. By using a blocked amine, one can expand and exaggerate this effect. Blocking one of the amino groups in TETA with lactose, for example, will dramatically increase the release rate achievable into a range that is more bioefficacious. Additionally, the erosion and decomposition of the sugar, along with its acidic by-products, can produce a self-triggering action when exposed to the environment. The following example demonstrate the differences in the effects.

External Phase (“EP”) Preparation:

Edible gelatin 150A (GP 4 from Hormel), 5.8 grams, was dissolved in 284.7 g of water. The solution was store at 50° C. until needed.

Internal Phase (“IP”) Preparation:

In a 16 ounce jar, 12.0 grams of a safener (3-(dichloroacetyl)-5-(2-furanyl)-2,2-dimethyloxazolidine, 95%) was dissolved in 360 g of Acetochlor, a corn herbicide, that was preheated to 500C. Then, 11.87 g of Desmodur N3200 (=6.486×10⁻² NCO equivalents, using N3200 equivalent wt of 183) and 15.84 g of m-TMXDI (=12.98×10⁻² NCO equivalents, using TMXDI equivalent weight of 122) were added. The solution was mixed until uniform, and then held at 50° C. until needed. (It contained a 33:67 blend of N3200:TMXDI isocyanate (NCO) equivalents, and a wall to core ratio of 10%.)

Blocked Amine/Crosslinker Preparation:

In a small jar, 9.49 g of TETA (=26×10⁻² equivalents, using TETA equivalent weight of 36.56) was mixed with 9.49 g of water. This amount of amine represents a 33% excess of amino equivalents (NH/NCO=26/19.5=1.33).

Microencapsulation:

The EP was weighed into a warm, small Waring Blender cup. With the blender running, the IP was added within a 1-minute interval. The emulsion was transferred into a 1 L beaker, and stirred with a three turbine blade impeller on a hot plate. The polyamine solution was added immediately at the start of the mixing (slight vortex maintained throughout). The mixture was heated for 2 hours at 50° C. to cure the shell wall. After 2 hours, 93% of the NCO groups were reacted as determined by IR absorbance at 2270 cm⁻¹. Then, 20.5 g of a 2% aqueous solution of Proxel GXL was added as a preservative. A slurry of microcapsules with a particle size of 3 microns (median) was obtained.

Release Testing:

Three 1 L dissolution vessels were prepared at three pH values: 8.2, 5.1 and 4.9. Then approx. 150 ppm of the formulation was added. The actual amount added times the assay equals the amount of Acetochlor added to the water. Samples from each vessel were taken at timed intervals, syringe filtered to remove capsules, and the filtered water was analyzed for free Acetochlor. The amount of Acetochlor detected in the water was plotted versus the square root of the time to determine the rate of release. The release half-life was determined by extrapolation (Higuchi Model of release). The results are summarized in Table E, below.

TABLE E

| Sample | Release Half-life | |
|---|---|---|
| Designation | (Higuchi) | pH of Release Media |
| 340D | 4427 days | 8.2 |
| 340A | 3063 days | 5.1 |
| 340C | 346 days | 4.9 |

From these results it may be observed that when the shell wall was made with an excess of amine, NH/NCO=1.33 (i.e., 4 amino equivalents for every 3 NCO equivalents), the release exhibited a pH dependence. The microcapsule with free amino group in the shell wall released faster under acidic conditions.

### Example 17

### Study of Blocking Reaction “Dwell Time”

The incorporation of a blocked amino group into the shell wall, wherein the blocking (amino directed protecting) agent is labile under acidic conditions, typically will increase the release rate in general and introduce a pH dependence into the release profile. As one would expect, the extent of reaction between the blocking agent and the amine is important to the ultimate release profile, as demonstrated by the following:

Microcapsule Preparation:

Four different microcapsule samples, as detailed in Table F, below, were prepared as in Example 16, above, with two changes. First, the EP was a solution of Sokalan CP 9 with a small amount of gelatin or casein. Second, the polyamine, TETA, was modified with a blocking agent. Specifically, lactose monohydrate (equivalent weight of 360) was added in sufficient amount to react with one of the amino groups in the TETA [1 mole of Lactose for 1 mole of TETA]. The only difference between the samples here was the time interval at which the lactose was allowed to react with the TETA (i.e., dwell time of blocking reaction). In 17A (Sample 243), the lactose was added to the EP so the reaction would take place simultaneously with shell wall formation (zero dwell time). In 17B (Sample 217), the lactose and TETA solution were allowed to react for 1 hour before being used. In 17C (Sample 276-C), the lactose and TETA solution were allowed to stand for 24 hours before using the solution. Finally, in 17D (Sample 275), the solution was held at room temperature for 60 days, and then used in the encapsulation procedure.

The formulations ingredients and procedural variants are listed in the Table F, below. Release testing was performed on the formulations as described above in Example 16. The (Higuchi) release half-lives obtained from “free Acetochlor” versus the square root of time plots are included in the Table.

TABLE F

| Ingredients/ | Sample | Sample | Sample | Sample |
|---|---|---|---|---|
| Process Variant | 243 | 217 | 276-C | 275 |
| EP | 290.65 g | 290.51 g | 291.38 g | 291.38 g |
| Water | 248.29 g | 266.69 g | 262.75 g | 262.75 g |
| Sokalan CP9 | 27.9 g | 23.24 g | 27.9 g | 27.9 g |
| (25% in aq.soln.) | | | | |
| 188MT | None | 0.58 g | None | None |
| Gelatin | | | | |
| Casein | None | None | 0.73 g | 0.73 g |
| Lactose | 14.46 g | None | None | None |
| IP | 388.85 g | 389.35 g | 389.35 g | 389.35 g |
| Acetochlor | 360 g | 360 | 360 g | 360 g |
| Technical | | | | |
| Safener | 12 g | 12 g | 12 g | 12 g |
| Desmodur | 7.16 g | 7.37 g | 7.37 q | 7.37 q |
| N3200 | | | | |
| m-TMXDI | 9.69 g | 9.98 g | 9.98 g | 9.98 g |
| Equivalent | 33:67 | 33:67 | 33:67 | 33:67 |
| Ratio, | | | | |
| N3200:TMXDI | | | | |
| NCO | (0.119) | (0.122) | (0.122) | (0.122) |
| equivalents | | | | |
| Blocked | 11.74 g | 39.71 g | 39.71 g | 39.71 g |
| Amine | | | | |
| TETA | 5.87 g | 5.73 g | 5.73 g | 5.73 g |
| Lactose* | None | 14.13 g | 14.13 g | 14.13 g |
| 1H₂O | | | | |
| Water | 5.87 g | 19.86 g | 19.86 g | 19.86 g |
| (Dwell | 0 | (1 hr) | (24 hrs) | (60 days) |
| Time) | | | | |
| (Amine | (0.160), | (0.118) | (0.118) | (0.118) |
| equivalents, | if all | this | assuming | assuming |
| eq.) | lactose | equals | all lactose | all |
| | reacts, | 0.157 | reacts with | lactose |
| | 0.04 | amino eq | TETA | reacts |
| | less | minus | | 1:1 with |
| | amino | 0.039 eq | | TETA |
| | eq., then | assuming | | |
| | free | all | | |
| | amino | lactose | | |
| | eq. = (0.12) | reacts | | |
| Formulation, | | | | Capsules |
| after 2 Hour | | | | could not |
| Cure, added | | | | be cured |
| | | | | beyond |
| | | | | 50% |
| Kelzan | None | None | 0.27 g | 0.27 g |
| 2% Proxel | 20.5 g | 20.5 g | 20.5 g | 20.5 g |
| GXL aq. Soln. | | | | |
| Release | | | | No |
| Half-life | | | | Encap. |
| in pH 7.0 Media | 244.5 days | 56.9 days | 14.9 days | — |
| in pH 4.0-4.5 | 79.1 days | 8.2 days | 9.7 days | — |
| Media | | | | |

For the results presented it may be observed that the introduction of lactose into the system acts to increase the release rate. As more time is granted for the lactose and TETA reaction, a larger increase in rate of release (i.e., decrease in release half-life) is observed. However, it may also be observed that if the reaction period is too long, side reactions may occur and even accumulate to effectively render the polyamine largely non-functional. This is believed to be the case for Sample 17D (275), where the 60 day dwell time allowed what is generally referred to as “Browning Reactions,” common between amino groups and sugars, to significantly reduce the number of reactive amino groups. This batch could not be successfully cured as a result of this loss.

These results suggests that for each blocking reaction, an optimum dwell time will exist that produces the maximum effect. This may vary with the nature of the blocking agent and reaction. Additionally, these results suggest that, for whatever dwell time selected, it is preferable this dwell time be monitored carefully, in order to obtain reproducible batches. For example, an in-process monitoring method may be advisable for each blocking reaction, to determine the degree of completion before using the blocked amine in an encapsulation.

### Example 18

### [206]

### Study of Blocking Post Encapsulation

This example was conducted in order to study an alternate approach to forming microcapsules having shell walls which contain blocked functionalities. More specifically, a sample of microcapsules was prepared which had free, unblocked amino groups in the shell walls thereof, in order to subject them to a post-cure treatment with a blocking agent.

EP Preparation:

In a jar, 23.24 grams of a 25% solution of a maleic/olefin copolymer, called Sokalan CP9, was mixed with 267.27 g of water. The solution was store at 50° C. until needed.

IP Preparation:

In a 16 ounce jar, 12.0 g of a safener (3-(dichloroacetyl)-5-(2-furanyl)-2,2-dimethyloxazolidine, 95%) was dissolved in 360 g of Acetochlor, a corn herbicide, that was preheated to 50° C. Then, 9.32 g of Desmodur N3200 (=5.093×10⁻² NCO equivalents, using N3200 equivalent wt of 183) and 12.63 g of m-TMXDI (=10.35×10⁻² NCO equivalents, using TMXDI equivalent weight of 122) were added. The solution was mixed until uniform, then held at 50° C. until needed.

This solution was found to contain a 33:67 blend of N3200:TMXDI isocyanate (NCO) equivalents, and the wall to core ratio was 7.9%. In this regard it is to be noted that the wall to core ratio is expected to increase to 10% with the addition of blocking agents (i.e., it will add about 2% weight to wall), added post encapsulation instead of pre-encapsulation.

Crosslinker (Polyamine) Solution:

In a small jar, 7.52 g of TETA (=20.57×10⁻² equivalents, using TETA equivalent weight of 36.56) was mixed with 7.52 g of water. This amount of amine represents a 33% excess of amino equivalents (NH/NCO=20.57/15.45=1.33).

Microencapsulation:

The EP was weighed into a warm small Waring Blender cup. With the blender running, the IP was added within a 1-minute interval. The emulsion was transferred into a 1L beaker, and stirred with a three turbine blade impeller on a hot plate. The polyamine solution was added immediately at the start of the mixing (slight vortex maintained throughout). The mixture was heated for 1 hour at 50° C. to cure the shell wall. Then, 20.5 g of a 2% aqueous solution of Proxel GXL was added as a preservative. A slurry of microcapsules with a particle size of 3 microns (median) was obtained (Sample 206).

Post-Treatments:

Sample 209-1: To 50 g of above capsule slurry, added 0.704 g of a 25% gluteraldehyde solution.
Sample 209-2: To 50 g of above capsule slurry, added 40% glyoxal.
Sample 209-3: To 50 g of above capsule slurry, added 0.633 g of Dextrose.
Sample 209-4: To 50 g of above capsule slurry, added 0.533 g of vanillin.
Sample 209-5: To 50 g of above capsule slurry, added 0.439 g of salicylaldehyde.
   All solutions were mixed with a “wrist action” shaker (on maximum) overnight. The next day, samples from above were taken for release testing (see below).
   Release Testing:

For each treatment sample above (i.e., Samples 209-1 through 209-5), two dissolution vessels with 1 L of water were prepared at two pH values: 7.0 (de-ionized water only, samples denoted “A” in Table G), and 4.4 (samples denoted “C” in Table G). The latter was prepared by mixing 56 g of a 0.1 M citric acid solution with 44 g of a 0.2 M Na₂HPO₄.2H₂O and 900.5 g of deionized water. Then, about 150 mg (target) of each formulation (i.e., Sample 209-1 through 209-5) was added to the dissolution vessels, and water was added until the total net weight was approximately 1 Kg (essentially 1 liter volume), the resulting dilutions containing approximately 150 parts per million (ppm), in essentially water (the actual weight added being recorded and used for the calculation of %released, however).

A target of 150 ppm was desired because the 206 formulation or sample contained 47.95% acetochlor. Therefore, by using this amount, one is effectively adding 71.9 ppm acetochlor (i.e., 150 ppm * 0.4795) to the vessel (i.e., total amount present). This is the amount of acetochlor that should be detected, if all the acetochlor is released. The ratio of the amount of acetochlor actually detected at a unit time in the water (outside the capsules, since they are filtered out when sampled) is divided by this total acetochlor present number to get the %released. The target value was set around 150 ppm for the formulation so that the amount of acetochlor present would be around 70 ppm, a fraction of the total water solubility of acetochlor, which is 240 ppm. This helps to ensure that the water media was acting like a perfect sink for the acetochlor moving out of the capsule into the water. If all the acetochlor releases, the amount of acetochlor in solution is still only about 29% of the maximum solubility of acetochlor in water. Once the media was saturated in acetochlor (240 ppm), release, diffusion into the water, will stop. As this point is approached, back diffusion (i.e., acetochlor moving from water into the capsule) becomes important. The analysis and release model assumed zero back diffusion into the capsule, which means to ensure validity of this assumption the saturation point is preferably avoided.

Samples from each vessel were taken at timed intervals, syringe filtered to remove capsules, and then the filtered water was analyzed for free acetochlor. The amount of acetochlor detected in the water was plotted versus the square root of the time to determine the rate of release. The release half-life was determined by extrapolation (Higuchi Model of release). The results are summarized below in Table G.

TABLE G

| Sample/ | Release Half-life | |
|---|---|---|
| Designation | (Higuchi) | pH of Release Media |
| 209-1A | 1549 days | 7.0 -> 7.19, end of test |
| 209-1C | 193 days | 4.4 -> 4.9, end of test |
| 209-4A | 1346 days | 7.0 -> 5.4, end of test |
| 209-4C | 144 days | 4.4 -> 4.75, end of test |
| 209-5A | 1690 days | 7.0 -> 7.4, end of test |
| 209-5C | 120 days | 4.4 -> not determined |
| 206A (untreated | 1193 days | 7.0 -> 5.8 |
| capsules) | | |
| 206C (untreated | 268 days | 4.4 -> 4.8 |
| capsules) | | |

From these results it is to be noted that, when the shell wall is made with an excess of amine (i.e., NH/NCO=1.33; that is, 4 amino equivalents for every 3 NCO equivalents), an amino group is available in the shell wall for a post-cure blocking reaction. However, the magnitude of the release and the differences in pH are small between the different treatments. More importantly, it is to be noted that the absolute values closely mirror the results from the untreated samples. Accordingly, these results suggests that the post-treatment approach may not be the preferred method of introducing an activatable site into the shell wall, in this particular instance, in as much as it is believed that the release behavior observed here is essentially attributable to the pH dependence observed when free amino groups are present in the shell wall.

While some of the compositions and methods of the present invention have been described in terms of preferred embodiments, it will be apparent to those of skill in the art that variations may be applied to the process described herein without departing from the concept, spirit and scope of the invention. Accordingly, all such similar substitutes and modifications apparent to those skilled in the art are deemed to be within the spirit, scope and concept of the invention.

1. A microcapsule comprising:
a substantially water-immiscible core material comprising a biologically active compound; and
a shell wall which encapsulates the core material;
wherein the shell wall is formed by an interfacial polymerization of an isocyanate monomer with an amine monomer in an encapsulation shell-forming polymerization, and further wherein said shell wall polymer backbone comprises a nitrogen-containing repeat unit therein and at least one blocking group, the breaking of a bond to said blocking group being effective to increase a rate at which the microcapsule releases the biologically active compound.

2. The microcapsule according to claim 1 wherein said blocking group is bound to a nitrogen atom in said nitrogen-containing repeat unit.

3. The microcapsule according to claim 1 wherein the blocking group is bonded to no more than one polymer backbone.

4. The microcapsule according to claim 1 wherein the blocking group is bonded to more than one polymer backbone.

5. The microcapsule according to claim 4 wherein the blocking group acts to crosslink the backbones of separate polymers.

6. The microcapsule according to claim 1 wherein the breaking of a bond to said blocking group does not degrade the polymer backbone.

7. The microcapsule according to claim 6 wherein a bond is broken between a nitrogen atom of the nitrogen-containing repeat unit and the blocking group.

8. The microcapsule according to claim 1 wherein the shell is semi-permeable to the biologically active compound prior to breaking of a bond to the blocking group.

9. The semi-permeable microcapsule according to claim 8 wherein, upon activation by breaking of a bond to the blocking group, said microcapsule has a half-life ranging from about 5 to about 150 days.

10. The microcapsule according to claim 1 wherein the shell is substantially impermeable with respect to the core material prior to activation by breaking of a bond to the blocking group.

11. The substantially impermeable microcapsule according to claim 10 wherein, prior to activation, said microcapsule has a half-life of at least about 6 months.

12. The microcapsule according claim 1 wherein the microcapsule is capable of releasing the biologically active compound by a mechanism consisting essentially of molecular diffusion.

13. The microcapsule accordingly to claim 12 wherein release of the biologically active compound occurs subsequent to breaking of a bond to the blocking group.

14. The microcapsule according to claim 1 wherein the polymer comprises a polyurea.

15. The microcapsule according to claim 1 wherein the blocking group is bonded to at least one tertiary amine nitrogen atom within the polymer backbone.

16. The microcapsule according to claim 1 wherein the agriculturally active chemical is selected from the group consisting of a herbicide, a herbicide safener, a pesticide, a fungicide, and combinations thereof.

17. The microcapsule according to claim 16 wherein the agriculturally active chemical is a herbicide.

18. The microcapsule according to claim 17 wherein the biologically active compound comprises an acetanilide.

19. The microcapsule according to claim 18 wherein the biologically active compound comprises acetochlor.

20. The microcapsule according to claim 18 wherein the biologically active compound comprises alachlor.

21. The microcapsule according to claim 18 further comprising 3-(dichloroacetyl)-5-(2-furanyl)-2,2-dimethyloxazolidine.

22. The microcapsule according to claim 16 wherein the biologically active compound comprises a herbicide and a herbicide safener.

23. The microcapsule according claim 1 wherein said amine monomer is a product of a blocking reaction between an amine reagent and a blocking agent.

24. The microcapsule according to claim 23 wherein a molar ratio of amine reagent to blocking agent in said blocking reaction ranges from about 4:0.25 to about 4:1.

25. The microcapsule according to claim 1 wherein the shell wall polymer is a product of a polymerization reaction between an isocyanate monomer and an amine monomer, followed by a subsequent blocking reaction wherein the shell wall polymer and a blocking agent are reacted to form a nitrogen-containing repeat unit in the polymer backbone having at least one blocking group thereon.

26. The microcapsule according to claim 1 wherein said amine monomer is selected from a group of polyfunctional amines consisting of substituted or unsubstituted polyethyleneamine, substituted or unsubstituted polyoxyethylenediamine, substituted or unsubstituted polyoxyethylenetriamine, substituted or unsubstituted polyoxypropylenediamine, substituted or unsubstituted polyoxypropylenetriamine, an amine epoxy adduct, or a mixture thereof.

27. The microcapsule according to claim 1 wherein said amine monomer is selected from a group of polyfunctional amines consisting of substituted or unsubstituted diethylene triamine, substituted or unsubstituted triethylene tetramine, substituted or unsubstituted iminobispropylamine, substituted or unsubstituted bis(hexamethylene)triamine, and a substituted or unsubstituted alkyl diamine or alkyl triamine having an alkyl chain from about 2 to about 6, or about 2 to about 4, carbons in length.

28. The microcapsule according to claim 23 wherein the blocking agent comprises a compound selected from the group consisting of an aldehyde, a ketone, a hemiacetal, an oxazolidine, an imidoester, an activated ester, or a combination thereof.

29. The microcapsule according to claim 25 wherein the blocking agent comprises a compound selected from the group consisting of an aldehyde, a ketone, a hemiacetal, an oxazolidine, an imidoester, an activated ester, or a combination thereof.

30. The microcapsule according to claim 1 wherein a bond to said blocking group is broken upon exposure to a pH ranging from about 3 to about 6.5.

31. The microcapsule according to claim 1 wherein a bond to said blocking group is broken upon exposure to a pH ranging from about 8 to about 10.

32. The microcapsule according to claim 1 wherein the polyisocyanate is selected from a group consisting of a trifunctional adduct of linear aliphatic isocyanate and a coupling reagent, a ring-containing aliphatic diisocyanate, an aromatic isocyanate, or a combination thereof.

33. A microcapsule according to claim 32 wherein the shell wall is formed by an interfacial polymerization comprising a first and a second isocyanate monomer.

34. A microcapsule according to claim 1 wherein, prior to activation by breaking of a bond to the blocking group, said microcapsule has a half-life that ranges from about 6 months to about 120 months.

35. A method of increasing a rate of release of an encapsulated biologically active compound from a microcapsule comprising a shell wall formed by an interfacial polymerization of an isocyanate monomer with an amine monomer in an encapsulation shell-forming polymerization, said shell wall polymer backbone comprises a nitrogen-containing repeat unit therein and at least one amine blocking group thereon, the method comprising contacting said microcapsule with a cleaving agent, the cleaving agent being selected to cleave a bond to the blocking group.

36. The method according to claim 35 wherein the cleaving agent comprises an hydronium ion.

37. The method according to claim 35 wherein the cleaving agent comprises an aqueous acid.

38. The method according to claim 35 wherein said cleaving agent is generated for cleaving a bond to said blocking group upon exposure to an external, environmental stimulus.

39. The method according to claim 38 wherein the cleaving agent comprises a photoacid generator which, upon exposure to said external, environmental stimulus, forms an acid which cleaves a bond to the blocking group.

40. The method according to claim 39 wherein said external, environmental stimulus is actinic radiation, said photoacid generator generating the acid upon exposure to said radiation.

41. The method according to claim 39 wherein said photoacid generator comprises a triarylsulfonium hexafluorophosphate salt.

42. The method according to claim 35 wherein a bond is cleaved between the blocking group and the polymer backbone.

43. The method according to claim 42 wherein a bond is cleaved between the blocking group a nitrogen atom in the nitrogen-containing repeat unit of the polymer backbone.

44. The method accordingly to claim 42 wherein said blocking group forms a crosslink within the shell wall, and further wherein a bond is cleaved within said blocking group to break the crosslink.

45. The method according to claim 35 wherein the blocking group is bonded to no more than one polymer backbone.

46. The method according to claim 35 wherein the blocking group is bonded to more than one polymer backbone.

47. The method according to claim 35 wherein the blocking group acts to crosslink the backbones of separate polymers.

48. The method according to claim 35 wherein the breaking of a bond to said blocking group does not degrade the polymer backbone.

49. The method according to claim 35 wherein a bond is broken between a nitrogen atom of the nitrogen-containing repeat unit and the blocking group.

50. The method according to claim 35 wherein the shell wall is semi-permeable to the biologically active compound prior to breaking of a bond to the blocking group.

51. The method according to claim 50 wherein, upon activation by breaking of a bond to the blocking group, said microcapsule has a half-life ranging from about 5 to about 150 days.

52. The method according to claim 35 wherein the shell is substantially impermeable with respect to the core material prior to activation by breaking of a bond to the blocking group.

53. The method according to claim 52 wherein, prior to activation, said microcapsule has a half-life of at least about 6 months.

54. The method according to claim 35 wherein the microcapsule is capable of releasing the biologically active compound by a mechanism consisting essentially of molecular diffusion.

55. A method for the preparation of an aqueous dispersion of microcapsules, the method comprising:
creating an oil-in-water emulsion comprising an aqueous external phase and a substantially water-immiscible internal phase, the external phase comprising water, an emulsifying agent, and a first amine monomer comprising an amine blocking group, said internal phase comprising an isocyanate monomer and a biologically active compound; and,
reacting the first amine monomer and the isocyanate monomer via interfacial polymerization to encapsulate a substantially water-immiscible core comprising the biologically active compound within a shell comprising a polymer which is a reaction product of the first amine monomer and the isocyanate monomer, wherein the polymer comprises a backbone and a blocking group bonded to an amine in the backbone and wherein the blocking group is subject to removal, removal of the blocking group being effective to increase a rate of release of the biologically active compound from the microcapsules.

56. The method according to claim 55 wherein the first amine monomer is added to the aqueous external phase subsequent to forming the emulsion.

57. The method according to claim 55 wherein the blocking group is bonded to no more than one polymer backbone.

58. The method according to claim 55 wherein the blocking group is bonded to more than one polymer backbone.

59. The method according to claim 55 wherein the blocking group acts to crosslink the backbones of separate polymers.

60. The method according to claim 55 wherein the breaking of a bond to said blocking group does not degrade the polymer backbone.

61. The method according to claim 55 wherein a bond is broken between a nitrogen atom of the nitrogen-containing repeat unit and the blocking group.

62. The method according to claim 55 wherein the shell wall is semi-permeable to the biologically active compound prior to breaking of a bond to the blocking group.

63. The method according to claim 62 wherein, upon activation by breaking of a bond to the blocking group, said microcapsule has a half-life ranging from about 5 to about 150 days.

64. The method according to claim 55 wherein the shell is substantially impermeable with respect to the core material prior to activation by breaking of a bond to the blocking group.

65. The method according to claim 64 wherein, prior to activation, said microcapsule has a half-life of at least about 6 months.

66. The method according to claim 55 wherein the microcapsule is capable of releasing the biologically active compound by a mechanism consisting essentially of molecular diffusion.

67. A method for the preparation of an aqueous dispersion of microcapsules, the method comprising:
creating an oil-in-water emulsion comprising an aqueous external phase and a substantially water-immiscible internal phase, the external phase comprising water, an emulsifying agent, a first amine monomer and a blocking agent effective for blocking the amine functional group of said first amine monomer, the internal phase comprising an isocyanate monomer and a biologically active compound;
reacting said first amine monomer and said blocking agent to form a blocked amine functional group; and,
reacting the first amine monomer and the isocyanate monomer via interfacial polymerization to encapsulate a substantially water-immiscible core comprising the biologically active compound within a shells comprising a polymer which is a reaction product of the amine monomer and the isocyanate monomer, wherein the polymer comprises a backbone and a blocking group bonded to an amine therein, and wherein breaking of a bond to the blocking group is effective to increase a rate of release of the biologically active compound from the microcapsules.

68. The method according to claim 67 wherein the first amine monomer is added to the aqueous external phase subsequent to forming the emulsion.

69. The method according to claim 67 wherein the blocking group is bonded to no more than one polymer backbone.

70. The method according to claim 67 wherein the blocking group is bonded to more than one polymer backbone.

71. The method according to claim 67 wherein the blocking group acts to crosslink the backbones of separate polymers.

72. The method according to claim 67 wherein the breaking of a bond to said blocking group does not degrade the polymer backbone.

73. The method according to claim 67 wherein a bond is broken between a nitrogen atom of the nitrogen-containing repeat unit and the blocking group.

74. The method according to claim 67 wherein the shell wall is semi-permeable to the biologically active compound prior to breaking of a bond to the blocking group.

75. The method according to claim 74 wherein, upon activation by breaking of a bond to the blocking group, said microcapsule has a half-life ranging from about 5 to about 150 days.

76. The method according to claim 67 wherein the shell is substantially impermeable with respect to the core material prior to activation by breaking of a bond to the blocking group.

77. The method according to claim 76 wherein, prior to activation, said microcapsule has a half-life of at least about 6 months.

78. The method according to claim 67 wherein the microcapsule is capable of releasing the biologically active compound by a mechanism consisting essentially of molecular diffusion.

79. A method for the preparation of an aqueous dispersion of microcapsules, the method comprising:
creating an oil-in-water emulsion comprising an aqueous external phase and a substantially water-immiscible internal phase, the external phase comprising water, an emulsifying agent, a first amine monomer, the internal phase comprising an isocyanate monomer and a biologically active compound;
reacting the first amine monomer and the isocyanate monomer via interfacial polymerization to encapsulate a substantially water-immiscible core comprising the biologically active compound within a shells comprising a polymer which is a reaction product of the amine monomer and the isocyanate monomer; and,
reacting said polymer with a blocking agent effective for blocking amine functional groups in said polymer to form a polymer comprising a backbone and a blocking group bound thereto, wherein breaking of a bond to the blocking group is effective to increase a rate of release of the biologically active compound from the microcapsules.

80. The method according to claim 79 wherein the blocking group is bonded to no more than one polymer backbone.

81. The method according to claim 79 wherein the blocking group is bonded to more than one polymer backbone.

82. The method according to claim 79 wherein the blocking group acts to crosslink the backbones of separate polymers.

83. The method according to claim 79 wherein the breaking of a bond to said blocking group does not degrade the polymer backbone.

84. The method according to claim 79 wherein a bond is broken between a nitrogen atom of the nitrogen-containing repeat unit and the blocking group.

85. The method according to claim 79 wherein the shell wall is semi-permeable to the biologically active compound prior to breaking of a bond to the blocking group.

86. The method according to claim 85 wherein, upon activation by breaking of a bond to the blocking group, said microcapsule has a half-life ranging from about 5 to about 150 days.

87. The method according to claim 79 wherein the shell is substantially impermeable with respect to the core material prior to activation by breaking of a bond to the blocking group.

88. The method according to claim 87 wherein, prior to activation, said microcapsule has a half-life of at least about 6 months.

89. The method according to claim 79 wherein the microcapsule is capable of releasing the biologically active compound by a mechanism consisting essentially of molecular diffusion.
